(19) United States
(12) Patent Application Publication
(10) Pub. No.: US 2026/0223917 A1
(43) Pub. Date: Aug. 6, 2026

(54) AEROSOL-GENERATING ARTICLE COMPRISING A COMBUSTION-PREVENTING UPSTREAM ELEMENT

(71) Applicant: Philip Morris Products S.A., Neuchatel (CH)

(72) Inventors: Stefanos PAPAKYRILLOU, Marin-Epagnier (CH); Eva SAADE LATORRE, Colombier (CH)

(73) Assignee: Philip Morris Products S.A., Neuchatel (CH)

(21) Appl. No.: 19/151,382

(22) PCT Filed: Jan. 29, 2024
(86) PCT No.: PCT/EP2024/052050

§ 371 Date: Jul. 28, 2025

(30) Foreign Application Priority Data
Feb. 2, 2023 (EP) 23386008.9

(51) Int. Cl. A24D 1/02; A24B 13/02; A24B 15/12; A24B 15/167; A24D 1/00; A24D 1/20; A24F 40/20; C09D 5/18; C09D 7/61; C09D 7/63; C09D 101/10; C09D 191/00

(52) U.S. Cl. CPC A24D 1/025; A24B 13/02; A24B 15/12; A24B 15/167; A24D 1/002; A24D 1/20; A24F 40/20; C09D 5/18; C09D 7/61; C09D 7/63; C09D 101/10; C09D 191/00

(57) ABSTRACT

An aerosol-generating article is provided, including: an aerosol-generating element comprising a rod of aerosol-generating substrate circumscribed by a rod plug wrap; an upstream element located upstream of the aerosol-generating element, the upstream element including a segment of material circumscribed by a first wrapper, and the segment of material including a convoluted sheet defining a plurality of longitudinally extending channels; and a second wrapper circumscribing both the upstream element and the aerosol-generating element, the first wrapper or the second wrapper or both the first wrapper and the second wrapper including a flame retardant composition including one or more flame retardant compounds at a location along the segment of material of the upstream element.

The present invention relates to an aerosol-generating article comprising an aerosol-generating element and adapted to produce an inhalable aerosol upon heating. In particular, the present invention relates to an aerosol-generating article comprising an upstream element located upstream of the aerosol-generating element. Aspects of the disclosure further relate to an aerosol-generating system comprising a heating device and an aerosol-generating article of the type set out above.

Aerosol-generating articles in which an aerosol-generating element comprising an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

Several aerosol-generating devices for consuming aerosol-generating articles have been disclosed in the art. Such devices include, for example, electrically heated aerosol-generating devices in which an aerosol is generated by the transfer of heat from one or more electrical heater elements of the aerosol-generating device to the aerosol-generating element of an aerosol-generating article. To this purpose, the aerosol-generating article is partially received within a heating cavity of the aerosol-generating device, such that an upstream end of the aerosol-generating article is inserted into the cavity whereas a downstream end of the aerosol-generating article projects out of the cavity. For example, electrically heated aerosol-generating devices have been proposed that comprise an internal heater blade which is adapted to be inserted into the aerosol-generating substrate when the aerosol-generating article is received within the heating cavity.

As an alternative, inductively heatable aerosol-generating articles have been proposed in WO 2015/176898. These aerosol-generating articles comprise an aerosol-generating element comprising an aerosol-generating substrate, such as a tobacco-containing substrate, and a susceptor arranged within the aerosol-generating substrate. Functional coupling between the susceptor and an inductive heater element of the aerosol-generating device is achieved when the aerosol-generating article is partially received within a heating cavity of the aerosol-generating device.

It is common for aerosol-generating articles of the types discussed above to include one or more additional elements that are assembled with the aerosol-generating element, usually by means of one or more wrappers. Individual elements forming part of an aerosol-generating article may each have their own wrapper (a so-called “plug wrap”). Two or more of the individual elements may be combined together by an “outer” wrapper. Examples of such additional elements include, but are not limited to, a mouthpiece segment (which may, for example, be in the form of a plug of a fibrous material, like cellulose acetate) arranged at the downstream end of the aerosol-generating article; a front element, that is, an element arranged at the upstream end of the aerosol-generating article; and a cooling element adapted to favour cooling of the aerosol generated upon heating the aerosol-generating substrate prior to the aerosol reaching the mouthpiece segment, and so forth. Where present, the mouthpiece segment is often attached to the remainder of the aerosol-generating article by means of tipping paper to mimic the typical appearance of conventional smoking articles.

During use, aerosol-generating articles of the types discussed above are exposed to heat provided by a heater element. Under these circumstances, conventional paper wrappers may be prone to becoming scorched or charred. In order to prevent this, and to desirably preserve a certain visual impact of the aerosol-generating article after its use, it has been proposed to combine a metallic foil, such as for example aluminium foil, with a paper layer to provide a wrapper capable of sustaining exposure to high temperatures for a longer time. In addition, use of a paper-metallic foil laminate has been found to increase safety and to prevent delivery of paper combustion or paper pyrolysis products to the consumer during use of the aerosol-generating article.

A need is generally felt to provide a novel and improved aerosol-generating article that is easier to dispose of and has a reduced environmental impact. Even more desirably, it would be beneficial to provide such an aerosol-generating article that is also adapted to prevent scorching or charring of the aerosol-generating article during use.

The present disclosure relates to an aerosol-generating article for generating an aerosol upon heating.

The aerosol-generating article may comprise an aerosol-generating element.

The aerosol-generating element may comprise a rod of aerosol-generating substrate. The aerosol-generating element may comprise a rod plug wrap circumscribing the rod of aerosol-generating substrate.

The aerosol-generating article may comprise an upstream element located upstream of the aerosol-generating element.

The upstream element may comprise a segment of material. The upstream element may comprise a first wrapper circumscribing the segment of material. The first wrapper may comprise a flame retardant composition at a location along the segment of material of the upstream element.

The aerosol-generating article may comprise a second wrapper circumscribing both the upstream element and the aerosol-generating element. The second wrapper may comprise a flame retardant composition at a location along the segment of material of the upstream element. According to a first aspect of the present invention, there is provided an aerosol-generating article for generating an aerosol upon heating. The aerosol-generating article comprises an aerosol-generating element comprising a rod of aerosol-generating substrate circumscribed by a rod plug wrap. The aerosol-generating article further comprises an upstream element located upstream of the aerosol-generating element, wherein the upstream element comprises a segment of material circumscribed by a first wrapper. Additionally, the aerosol-generating article comprises a second wrapper circumscribing both the upstream element and the aerosol-generating element. The first wrapper or the second wrapper or both comprise a flame retardant composition comprising one or more flame retardant compounds at a location along the segment of material of the upstream element.

As used herein with reference to the invention, the term “aerosol-generating article” is used to describe an article comprising an aerosol-generating substrate that is heated to generate an inhalable aerosol for delivery to a user.

As used herein with reference to the invention, the term “aerosol-generating substrate” is used to describe a substrate comprising aerosol-generating material that is capable of releasing upon heating volatile compounds that can generate an aerosol.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein with reference to the invention, the term “aerosol-generating device” is used to describe a device that interacts with the aerosol-generating substrate of the aerosol-generating article to generate an aerosol.

Aerosol-generating articles according to the invention have a proximal end through which, in use, an aerosol exits the aerosol-generating article for delivery to a user. The proximal end of the aerosol-generating article may also be referred to as the downstream end or the mouth end of the aerosol-generating article. In use, a user draws directly or indirectly on the proximal end of the aerosol-generating article in order to inhale an aerosol generated by the aerosol-generating article.

Aerosol-generating articles according to the invention have a distal end. The distal end is opposite the proximal end. The distal end of the aerosol-generating article may also be referred to as the upstream end of the aerosol-generating article.

Components of aerosol-generating articles according to the invention may be described as being upstream or downstream of one another based on their relative positions between the proximal end of the aerosol-generating article and the distal end of the aerosol-generating article.

As used herein with reference to the invention, the term “longitudinal” is used to describe the direction between the upstream end and the downstream end of the aerosol-generating article. During use, air is drawn through the aerosol-generating article in the longitudinal direction. As used herein with reference to the invention, the term “length” is used to describe the maximum dimension of the aerosol-generating article or a component of the aerosol-generating article in the longitudinal direction.

As used herein with reference to the invention, the term “transverse” is used to describe the direction perpendicular to the longitudinal direction. Unless otherwise stated, references to the “cross-section” of the aerosol-generating article or a component of the aerosol-generating article refer to the transverse cross-section.

As used herein with reference to the invention, the term “width” denotes the maximum dimension of the aerosol-generating article or a component of the aerosol-generating article in a transverse direction. Where the aerosol-generating article has a substantially circular cross-section, the width of the aerosol-generating article corresponds to the diameter of the aerosol-generating article. Where a component of the aerosol-generating article has a substantially circular cross-section, the width of the component of the aerosol-generating article corresponds to the diameter of the component of the aerosol-generating article.

As used herein with reference to the invention, the term “hollow tubular element” is used to denote a generally cylindrical element having a lumen along a longitudinal axis thereof. The tubular portion may have a substantially circular, oval or elliptical cross-section. The lumen may have a substantially circular, oval or elliptical cross-section. In particular, the term “hollow tubular element” is used to denote an element defining at least one airflow conduit establishing an uninterrupted fluid communication between an upstream end of the hollow tubular element and a downstream end of the tubular element.

Unless otherwise specified, the resistance to draw (RTD) of a component or an aerosol-generating article in accordance with the invention is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 and are normally carried out at a volumetric flow rate of about 17.5 millilitres per second at the output or downstream end of the measured component, at a temperature of about 22 degrees Celsius, a pressure of about 101 kPa (about 760 Torr) and a relative humidity of about 60%.

The expression “resistance to draw (RTD) per unit length” of a particular component (or element) of the aerosol-generating article, such as the upstream element, the aerosol-generating element, and so forth, can be calculated by dividing the measured resistance to draw of the component by the total axial length of the component. The RTD per unit length refers to the pressure required to force air through a unit length of a component. Throughout the present disclosure, a unit length refers to a length of 1 millimetre. Accordingly, in order to derive the RTD per unit length of a particular component, a specimen of a particular length, 15 millimetres for example, of the component can be used in measurement. The RTD of such a specimen is measured in accordance with ISO 6565-2015. If, for example, the measured RTD is about 15 millimetres H₂O, then the RTD per unit length of the component is about 1 millimetre H₂O per millimetre. The RTD per unit length of the component is generally dependent on the structural properties of the material used for the component as well as the cross-sectional geometry or profile of the component, amongst other factors.

As described briefly above, an aerosol-generating article according to an aspect of the present invention comprises an aerosol-generating element and an upstream element located upstream of the aerosol-generating element, wherein the upstream element comprises a segment of material circumscribed by a first wrapper. In the aerosol-generating article, a second wrapper circumscribes both the upstream element and the aerosol-generating element, for example to combine them. In contrast to existing aerosol-generating articles, one or both of the first wrapper and the second wrapper comprise a flame retardant composition comprising one or more flame retardant compounds at a location along the segment of material of the upstream element.

Circumscribing the upstream element with a wrapper comprising a flame retardant composition at a location along the segment of material of the upstream element is beneficial in that it helps prevent combustion of the upstream element. As a result, if a user attempts to light up an aerosol-generating article according to the invention at its distal end-like they would do with a conventional cigarette—the combustion front is stopped before it can advance all the way to the aerosol-generating element. Thus, improper use of aerosol-generating articles destined to be heated in an ad hoc device to generate an inhalable aerosol is desirably prevented.

Additionally, by circumscribing the upstream element with a wrapper comprising a flame retardant composition at a location along the segment of material of the upstream element it is advantageously possible to prevent the wrapper or wrappers and the underlying segment of material from charring or scorching upon heating during the intended use of the aerosol-generating article in combination with a heating device. This desirable effect is achieved without the need for an additional layer of metallic foil or other heat-shielding material in the article. In particular, the inventors have found that by using a wrapper or wrappers in line with the invention, it is possible substantially avoid occurrences of charring or scorching of the wrapper(s) or of the underlying segment of material when the upstream element is exposed to temperatures in the range from 150 to 370 degrees Celsius. This is advantageous both in aerosol-generating devices wherein heat is supplied by means of a resistive heater element inserted into an aerosol-generating substrate, which may for example reach temperatures close to 350 degrees Celsius, and in aerosol-generating devices wherein heat is supplied inductively by means of a susceptor element embedded in an aerosol-generating substrate, which may for example reach temperatures close to 260 degrees Celsius.

Aerosol-generating articles according to the invention are easy to dispose of after use, and have a reduced environmental impact, as there is no need to include a metallic foil layer as a heat shield as is commonly the case in existing aerosol-generating articles.

The advantageous effects described above are especially welcome in embodiments of the aerosol-generating article wherein the upstream element is formed entirely or predominantly of easily flammable materials, such as crimped paper and/or cardboard, which represent a more eco-friendly, cost-effective alternative to other known materials. Use of a flame retardant composition in line with the present invention instead of a band of metallic foil adds to the already high level of eco-friendliness of the article as a whole.

By adjusting the amount of flame retardant composition in or on the wrapper or wrappers—for example, in terms of amount per square metre of surface area of wrapper base material, the extent to which the surface of the wrapper or wrappers is treated with the flame retardant composition, as well as the formulation of the flame retardant composition itself—it is advantageously possible to enhance the flame retardant properties of the distal portion of the aerosol-generating article and, to an extent, of the aerosol-generating article as a whole.

Aerosol-generating articles according to the invention can be manufactured efficiently and at high speed without the need for extensive modification of existing equipment.

In some embodiments, the first wrapper comprises a wrapping base material and the flame retardant composition is provided on a surface of the wrapping base material facing the segment of material of the upstream element, a surface of the wrapping base material facing away from the segment of material of the upstream element, or both.

Preferably, the second wrapper comprises a wrapping base material and the flame retardant composition is provided on a surface of the wrapping base material facing the segment of material of the upstream element, a surface of the wrapping base material facing away from the segment of material of the upstream element, or both.

Thus, a number of different possible arrangements are possible. Providing the flame retardant composition closer to or farther away from the segment of material of the upstream element may have some impact in that some of the flame retardant composition may more or less easily migrate into the segment of material. In the context of the present invention, some degree of migration of the flame retardant composition into the segment of material may be advantageous in that it may further contribute to preventing combustion of the segment of material in cases of misuse of the aerosol-generating article.

As described briefly above, in aerosol-generating articles in accordance with the present invention the wrapper or wrappers circumscribing the upstream element comprise a flame retardant composition comprising one or more flame retardant compounds at a location along the segment of material of the upstream element. In practice, at least one of the wrappers comprises a wrapping base material and the flame retardant composition comprising one or more flame retardant compounds may be applied as a coating onto the wrapping base material or the wrapping base material may be impregnated with the flame retardant composition or both. As a further alternative, a flame retardant composition comprising one or more flame retardant compounds may be incorporated into the wrapper or wrappers during manufacture of the wrapping material itself. For example, during manufacture of a paper-based or polymer-based wrapping material, the flame retardant composition may be added to the pulp or polymeric mixture during the wrapper manufacturing process. This may be advantageous in that the manufacturing process is shortened and it may be possible to obtain a more homogeneous distribution of the flame retardant compounds throughout the wrapping material.

The term “flame retardant compounds” is used herein to describe chemical compounds that, when applied onto or otherwise incorporated into a substrate, such as paper or plastic compounds, provide the substrate with varying degrees of flammability protection. In practice, flame retardant compounds may be activated by the presence of an ignition source and are adapted to prevent or slow the further development of ignition by a variety of different physical and chemical mechanisms.

A flame retardant composition may typically further comprise one of more non-flame retardant compounds, that is, one or more compound-such as a solvent, an excipient, a filler—that does not actively contribute to providing the substrate with flammability protection, but is used to facilitate the application of the flame retardant compound or compounds onto or into the wrapper or both.

Some of the non-flame retardant compounds of a flame retardant composition-such as solvents—are volatile and may evaporate from the wrapper upon drying after the flame retardant composition has been applied onto or into the wrapping base material or both. As such, although such non-flame retardant compounds form part of the formulation of the flame retardant composition, they may no longer be present or they may only be detectable in trace amounts in the wrapper or wrappers of an aerosol-generating article in accordance with the invention.

To provide a flame retardant composition in a paper-based or polymer-based wrapper, the flame retardant composition may be added to the pulp or polymeric mixture during the wrapper manufacturing process, or added to the wrapping base material at a later stage by an application process based on size pressing, spraying, printing, coating, etc. The flame retardant composition may be applied, for example as a layer, onto one side of a wrapping base material or on both sides of the wrapping base material.

A number of suitable flame retardant compounds are known. Some flame retardant compounds, such as mineral flame retardants mainly act as additive flame retardants, and do not become chemically attached to the surrounding system. Most of the organo-halogen and organo-phosphate compounds also do not react permanently to attach themselves into their surroundings. Reactive flame retardant compounds, such as certain non-halogenated products, are reactive in that they become integrated in the surrounding system without losing their retardant efficiency. This makes these materials advantageously non-emissive into the environment.

The wrapping base material of the wrapper or wrappers circumscribing the segment of material of the upstream element may be a paper wrapping base material or a non-paper wrapping base material. In preferred embodiments, the wrapping base material of the wrapper circumscribing the segment of material of the upstream element comprises paper. Suitable paper wrapping base materials for use in specific embodiments of the invention are known in the art and include, but are not limited to: cigarette papers; and filter plug wraps. Suitable non-paper wrapping base materials for use in specific embodiments of the invention are known in the art and include, but are not limited to sheets of homogenised tobacco materials and sheets of certain polymeric materials. In certain embodiments, the wrapping base material may be formed of a laminate material comprising a plurality of layers.

In some embodiments, the wrapping base material of the wrapper or wrappers circumscribing the segment of material of the upstream element may be non-porous. In particular, the wrapping base material of the first wrapper may be non-porous.

In some embodiments, the wrapping base material of the first wrapper may have an air permeability of less than about 20 Coresta units.

The “Coresta unit” is the unit of air permeability of a sheet material, which corresponds to the flow of air (cubic centimetres per minute) passing through a 1 square centimetre surface area of the test material at a measuring pressure of 1.00 kPa. The measuring pressure is the difference in pressure between the two faces of the test material during measurement. As such, the units corresponding to the Coresta unit are cubic centimetres per minute per square centimetre (cm³ min⁻¹ cm⁻²) at 1.00 kPa. A suitable method for determining the air permeability of sheet materials for use in the present invention is described in ISO Standard 2965:2009.

The air permeability in Coresta units (CU) for a test piece is calculated using the formula:

$$CU = [ Q / A ] \times [ 1 / d ]$$

where Q is the measured air flow, in cubic centimetres per minute, passing through the test piece, A is the surface area, in square centimetres, of the test piece, and d is the actual measure of pressure difference, in kilopascals, across the two surfaces of the test piece.

A wrapper having an air permeability of less than 20 Coresta units may also be described herein as “substantially impermeable”. In preferred embodiments, the first wrapper has an air permeability of less than 20 Coresta units, more preferably less than 10 Coresta units, and even more preferably less than 5 Coresta units. In some particularly preferred embodiments, the air permeability of the substantially impermeable wrapper can have a lower limit of 1 Coresta unit.

By way of example, the wrapping base material may have a basis weight of at least about 20 grams per square metre. Preferably, the wrapping base material has a basis weight of at least about 25 grams per square metre. More preferably, the wrapping base material has a basis weight of at least about 30 grams per square metre. Even more preferably, the wrapping base material has a basis weight of at least about 40 grams per square metre.

The wrapping base material may have a basis weight of up to about 120 grams per square metre. Preferably, the wrapping base material has a basis weight of less than or equal to about 110 grams per square metre. More preferably, the wrapping base material has a basis weight of less than or equal to about 100 grams per square metre. Even more preferably, the wrapping base material has a basis weight of less than or equal to about 90 grams per square metre.

In some embodiments, the wrapping base material may have a basis weight from about 20 grams per square metre to about 120 grams per square metre, preferably from about 25 grams per square metre to about 120 grams per square metre, more preferably from about 30 grams per square metre to about 120 grams per square metre, even more preferably from about 40 grams per square metre to about 120 grams per square metre. In other embodiments, the wrapping base material may have a basis weight from about 20 grams per square metre to about 110 grams per square metre, preferably from about 25 grams per square metre to about 110 grams per square metre, more preferably from about 30 grams per square metre to about 110 grams per square metre, even more preferably from about 40 grams per square metre to about 110 grams per square metre. In further embodiments, the wrapping base material may have a basis weight from about 20 grams per square metre to about 100 grams per square metre, preferably from about 25 grams per square metre to about 100 grams per square metre, more preferably from about 30 grams per square metre to about 100 grams per square metre, even more preferably from about 40 grams per square metre to about 100 grams per square metre. In yet other embodiments, the wrapping base material may have a basis weight from about 20 grams per square metre to about 90 grams per square metre, preferably from about 25 grams per square metre to about 90 grams per square metre, more preferably from about 30 grams per square metre to about 90 grams per square metre, even more preferably from about 40 grams per square metre to about 90 grams per square metre.

For example, the first wrapper circumscribing the segment of material of the upstream element may comprise a wrapping base material having a basis weight of up to 100 grams per square metre.

For example, the second wrapper circumscribing both the upstream element and the aerosol-generating element—that is, for example, the wrapper combining the upstream element and the aerosol-generating element—may comprise a wrapping base material having a basis weight of from 20 grams per square metre to 60 grams per square metre, preferably from 25 grams per square metre to 50 grams per square metre.

The wrapping base material may have a thickness of at least 20 micrometres. Preferably, the wrapping base material has a thickness of at least 25 micrometres. More preferably, the wrapping base material has a thickness of at least 30 micrometres.

The wrapping base material may have a thickness of less than or equal to 130 micrometres. Preferably, the wrapping base material has a thickness of less than or equal to 120 micrometres. More preferably, the wrapping base material has a thickness of less than or equal to 110 micrometres. Even more preferably, the wrapping base material has a thickness of less than or equal to 100 micrometres or less than or equal to 90 micrometres.

In some embodiments, the wrapping base material has a thickness from 20 micrometres to 130 micrometres, preferably from 20 micrometres to 120 micrometres, more preferably from 20 micrometres to 110 micrometres, even more preferably from 20 micrometres to 100 micrometres or from 20 micrometres to 90 micrometres. In other embodiments, the wrapping base material has a thickness from 25 micrometres to 130 micrometres, preferably from 25 micrometres to 120 micrometres, more preferably from 25 micrometres to 110 micrometres, even more preferably from 25 micrometres to 100 micrometres or from 25 micrometres to 90 micrometres. In further embodiments, the wrapping base material has a thickness from 30 micrometres to 130 micrometres, preferably from 30 micrometres to 120 micrometres, more preferably from 30 micrometres to 110 micrometres, even more preferably from 30 micrometres to 100 micrometres or from 30 micrometres to 90 micrometres.

For example, the first wrapper circumscribing the segment of material of the upstream element may comprise a wrapping base material having a thickness of up to 125 micrometres.

For example, the second wrapper circumscribing both the upstream element and the aerosol-generating element—that is, for example, the wrapper combining the upstream element and the aerosol-generating element—may have a thickness of from 40 micrometres to 75 micrometres.

The wrapper circumscribing at least the rod of aerosol-generating substrate has an overall dry basis weight which is the sum of the basis weight of the wrapping base material and the weight of flame retardant composition components that are present on a surface of the wrapping base material or within the wrapping base material or both. The weight of flame retardant composition components present on or in the wrapper is the sum of the total weight of flame retardant compound or compounds and the weight of any residual non-flame retardant compounds. Within the context of the present invention, the weight of flame retardant composition components is also expressed in grams of components per square metre of wrapping base material.

The ratio of total weight of flame retardant compound(s) to overall dry basis weight of the wrapper may be regarded as an indication of the concentration of flame retardant compound(s) in the wrapper.

In aerosol-generating articles in accordance with the present invention, a ratio of total weight of flame retardant compound(s) to overall dry basis weight of the wrapper may be at least about 0.02. Preferably, a ratio of total weight of flame retardant compound(s) to overall dry basis weight of the wrapper is at least about 0.03. More preferably, a ratio of total weight of flame retardant compound(s) to overall dry basis weight of the wrapper is at least about 0.04. Even more preferably, a ratio of total weight of flame retardant compound(s) to overall dry basis weight of the wrapper is at least about 0.05.

Preferably, a ratio of total weight of flame retardant compound(s) to overall dry basis weight of the wrapper is less than or equal to about 0.20. More preferably, a ratio of total weight of flame retardant compound(s) to overall dry basis weight of the wrapper is less than or equal to about 0.15. Even more preferably, a ratio of total weight of flame retardant compound(s) to overall dry basis weight of the wrapper is less than or equal to about 0.10.

In some embodiments, a ratio of total weight of flame retardant compound(s) to overall dry basis weight of the wrapper may be from about 0.02 to about 0.20, preferably from about 0.03 to about 0.20, more preferably from about 0.04 to about 0.20, even more preferably from about 0.05 to about 0.20. In other embodiments, a ratio of total weight of flame retardant compound(s) to overall dry basis weight of the wrapper may be from about 0.02 to about 0.15, preferably from about 0.03 to about 0.15, more preferably from about 0.04 to about 0.15, even more preferably from about 0.05 to about 0.15. In further embodiments, a ratio of total weight of flame retardant compound(s) to overall dry basis weight of the wrapper may be from about 0.02 to about 0.10, preferably from about 0.03 to about 0.10, more preferably from about 0.04 to about 0.10, even more preferably from about 0.05 to about 0.10.

In an aerosol-generating article in accordance with the present invention, the flame retardant composition is provided in a treated portion of the wrapper. This means that the flame retardant composition has been applied onto or into a corresponding portion of the wrapping base material or both. Thus, in the treated portion, the wrapper has an overall dry basis weight that is greater than the dry basis weight of the wrapping base material.

The treated portion of the wrapper may extend over at least about 10 percent of an outer surface area of the segment of material of the upstream element circumscribed by the wrapper. Preferably, the treated portion of the wrapper extends over at least about 20 percent of an outer surface area of the segment of material of the upstream element circumscribed by the wrapper. More preferably, the treated portion of the wrapper extends over at least about 40 percent of an outer surface area of the segment of material of the upstream element. Even more preferably, the treated portion of the wrapper extends over at least about 60 percent of an outer surface area of the segment of material of the upstream element. Most preferably, the treated portion of the wrapper extends over at least about 80 percent of an outer surface area of the segment of material of the upstream element.

In particularly preferred embodiments, the treated portion of the wrapper extends over at least about 90 percent of an outer surface area of the segment of material of the upstream element. Even more preferably, the treated portion of the wrapper extends over at least about 95 percent of an outer surface area of the segment of material of the upstream element. Most preferably, the treated portion of the wrapper extends substantially over the entire outer surface area of the segment of material of the upstream element.

A length of the treated area may be at least about 10 percent of a length of the segment of material of the upstream element. Preferably, a length of the treated area is at least about 20 percent of a length of the segment of material of the upstream element. More preferably, a length of the treated area is at least about 40 percent of a length of the segment of material of the upstream element. Even more preferably, a length of the treated area is at least about 60 percent of a length of the segment of material of the upstream element. Most preferably, a length of the treated area is at least about 80 percent of a length of the segment of material of the upstream element.

In particularly preferred embodiments, a length of the treated area is at least about 90 percent of a length of the segment of material of the upstream element. Even more preferably, a length of the treated area is at least about 95 percent of a length of the segment of material of the upstream element. Most preferably, a length of the treated area is substantially equal to a length of the segment of material of the upstream element.

At least about 10 grams of the flame retardant composition may be applied onto the treated portion per square metre of surface area of the treated portion. Preferably, at least about 12 grams of the flame retardant composition are applied onto the treated portion per square metre of surface area of the treated portion. More preferably, at least about 14 grams of the flame retardant composition are applied onto the treated portion per square metre of surface area of the treated portion. Even more preferably, at least about 16 grams of the flame retardant composition are applied onto the treated portion per square metre of surface area of the treated portion. In particularly preferred embodiments, at least about 18 grams or at least about 20 grams of the flame retardant composition are applied onto the treated portion per square metre of surface area of the treated portion.

Preferably, less than or equal to about 35 grams of the flame retardant composition are applied onto the treated portion per square metre of surface area of the treated portion. More preferably, less than or equal to about 30 grams of the flame retardant composition are applied onto the treated portion per square metre of surface area of the treated portion. Even more preferably, less than or equal to about 25 grams of the flame retardant composition are applied onto the treated portion per square metre of surface area of the treated portion.

In some embodiments, from about 10 grams to about 35 grams of the flame retardant composition are applied onto the treated portion per square metre of surface area of the treated portion. Preferably, from about 12 grams to about 35 grams of the flame retardant composition are applied onto the treated portion per square metre of surface area of the treated portion. More preferably, from about 14 grams to about 35 grams of the flame retardant composition are applied onto the treated portion per square metre of surface area of the treated portion. Even more preferably, from about 16 grams to about 35 grams of the flame retardant composition are applied onto the treated portion per square metre of surface area of the treated portion. In particularly preferred embodiments, from about 18 grams to about 35 grams or from about 20 grams to about 35 grams of the flame retardant composition are applied onto the treated portion per square metre of surface area of the treated portion.

In other embodiments, from about 10 grams to about 30 grams of the flame retardant composition are applied onto the treated portion per square metre of surface area of the treated portion. Preferably, from about 12 grams to about 30 grams of the flame retardant composition are applied onto the treated portion per square metre of surface area of the treated portion. More preferably, from about 14 grams to about 30 grams of the flame retardant composition are applied onto the treated portion per square metre of surface area of the treated portion. Even more preferably, from about 16 grams to about 30 grams of the flame retardant composition are applied onto the treated portion per square metre of surface area of the treated portion. In particularly preferred embodiments, from about 18 grams to about 30 grams or from about 20 grams to about 30 grams of the flame retardant composition are applied onto the treated portion per square metre of surface area of the treated portion.

In further embodiments, from about 10 grams to about 25 grams of the flame retardant composition are applied onto the treated portion per square metre of surface area of the treated portion. Preferably, from about 12 grams to about 25 grams of the flame retardant composition are applied onto the treated portion per square metre of surface area of the treated portion. More preferably, from about 14 grams to about 25 grams of the flame retardant composition are applied onto the treated portion per square metre of surface area of the treated portion. Even more preferably, from about 16 grams to about 25 grams of the flame retardant composition are applied onto the treated portion per square metre of surface area of the treated portion. In particularly preferred embodiments, from about 18 grams to about 25 grams or from about 20 grams to about 25 grams of the flame retardant composition are applied onto the treated portion per square metre of surface area of the treated portion.

The treated portion of the wrapper may comprise at least about 0.1 grams of the flame retardant compound or compounds per square metre of surface area of the treated portion.

Preferably, the treated portion of the wrapper comprises at least about 0.5 grams of the flame retardant compound or compounds per square metre of surface area of the treated portion. More preferably, the treated portion of the wrapper comprises at least about 1.0 grams of the flame retardant compound or compounds per square metre of surface area of the treated portion. Even more preferably, the treated portion of the wrapper comprises at least about 2.0 grams of the flame retardant compound or compounds per square metre of surface area of the treated portion. In particularly preferred embodiments, the treated portion of the wrapper comprises at least about 3.0 grams of the flame retardant compound or compounds per square metre of surface area of the treated portion or at least about 4.0 grams of the flame retardant compound or compounds per square metre of surface area of the treated portion or at least about 5.0 grams of the flame retardant compound or compounds per square metre of surface area of the treated portion.

In some embodiments, the treated portion of the wrapper comprises at least about 10 grams of the flame retardant compound or compounds per square metre of surface area of the treated portion.

Preferably, the treated portion of the wrapper comprises less than or equal to about 100 grams of the flame retardant compound or compounds per square metre of surface area of the treated portion. More preferably, the treated portion of the wrapper comprises less than or equal to about 50 grams of the flame retardant compound or compounds per square metre of surface area of the treated portion. Even more preferably, the treated portion of the wrapper comprises less than or equal to about 25 grams of the flame retardant compound or compounds per square metre of surface area of the treated portion.

In some embodiments, the treated portion of the wrapper comprises from about 0.5 grams to about 12 grams of the flame retardant compound or compounds per square metre of surface area of the treated portion, preferably from about 1.0 grams to about 12 grams of the flame retardant compound or compounds per square metre of surface area of the treated portion, more preferably from about 2.0 grams to about 12 grams of the flame retardant compound or compounds per square metre of surface area of the treated portion, even more preferably from about 3.0 grams to about 12 grams of the flame retardant compound or compounds per square metre of surface area of the treated portion.

In other embodiments, the treated portion of the wrapper comprises from about 0.5 grams to about 10 grams of the flame retardant compound or compounds per square metre of surface area of the treated portion, preferably from about 1.0 grams to about 10 grams of the flame retardant compound or compounds per square metre of surface area of the treated portion, more preferably from about 2.0 grams to about 10 grams of the flame retardant compound or compounds per square metre of surface area of the treated portion, even more preferably from about 3.0 grams to about 120 grams of the flame retardant compound or compounds per square metre of surface area of the treated portion.

In further embodiments, the treated portion of the wrapper comprises from about 0.5 grams to about 8 grams of the flame retardant compound or compounds per square metre of surface area of the treated portion, preferably from about 1.0 grams to about 12 grams of the flame retardant compound or compounds per square metre of surface area of the treated portion, more preferably from about 2.0 grams to about 8 grams of the flame retardant compound or compounds per square metre of surface area of the treated portion, even more preferably from about 3.0 grams to about 8 grams of the flame retardant compound or compounds per square metre of surface area of the treated portion.

In some particularly preferred embodiments, the treated portion of the wrapper comprises from about 10 grams to about 100 grams of the flame retardant compound or compounds per square metre of surface area of the treated portion, preferably from about 10 grams to about 50 grams of the flame retardant compound or compounds per square metre of surface area of the treated portion, more preferably from about 10 grams to about 25 grams of the flame retardant compound or compounds per square metre of surface area of the treated portion.

In aerosol-generating articles in accordance with the present invention, a content of the flame retardant compound or compounds in the treated portion is preferably such that, when the aerosol-generating article is heated at 500 degrees Celsius using a resistively heated coil for at least 5 seconds, preferably for 30 seconds the aerosol-generating article does not ignite. The term “does not ignite” is used here to mean in particular that combustion of the wrapper circumscribing the aerosol-generating substrate is not initiated, and no flame is detected.

Preferably, the aerosol-generating articles in accordance with the present invention do not ignite when submitted to the Health Canada Intense regime, which comprises a pre-lighting step using a resistively heated coil, and at a puffing regime of one puff of 55 millilitres and 2 seconds duration every 30 seconds with 100 percent of the ventilation zone on the aerosol-generating article (if present) blocked. Further details about the “smoking” parameters and standard testing conditions to are provided in ISO 3308:2000 (Routine analytical cigarette-smoking machine-Definitions and standard conditions).

A number of suitable flame retardant compounds will be known to the skilled person. In particular, several flame retardant compounds and formulations suitable for treating cellulosic materials are known and have been disclosed and may find use in the manufacture of wrappers for aerosol-generating articles in accordance with the present invention.

In some embodiments, the flame retardant composition comprises a polymer and a mixed salt based on at least one mono, di- and/or tri-carboxylic acid, at least one polyphosphoric, pyrophosphoric and/or phosphoric acid, and a hydroxide or a salt of an alkali or an alkaline earth metal, where the at least one mono, di- and/or tri-carboxylic acid and the hydroxide or salt form a carboxylate and the at least one polyphosphoric, pyrophosphoric and/or phosphoric acid and the hydroxide or salt form a phosphate.

Preferably, in such embodiments the flame retardant composition further comprises a carbonate of an alkali or an alkaline earth metal.

In other embodiments, the flame retardant composition comprises cellulose modified with at least one C₁₀ or higher fatty acid, tall oil fatty acid (TOFA), phosphorylated linseed oil, phosphorylated downstream corn oil. Preferably, the at least one C₁₀ or higher fatty acid is selected from the group consisting of capric acid, myristic acid, palmitic acid, and combinations thereof.

Preferably, in aerosol-generating articles according to the present invention neither one of the first wrapper and the second wrapper comprises metal. This may advantageously enhance the eco-friendliness of aerosol-generating articles in accordance with the present invention, since at the time of disposal, there is no need to separate the metallic component or components from the remainder of the article.

In some embodiments, the upstream element is arranged immediately upstream of the aerosol-generating element. Preferably, the upstream element abuts an upstream end of the aerosol-generating article. Thus, the upstream element may extend from an upstream end of the aerosol-generating element to an upstream or distal end of the aerosol-generating article.

In other embodiments, the aerosol-generating article comprise one or more intermediate components disposed between the upstream element and the aerosol-generating element. Preferably, the upstream element abuts an upstream end of one such intermediate component disposed immediately downstream of the upstream element. Thus, the upstream element may extend from an upstream end of the intermediate component to an upstream or distal end of the aerosol-generating article.

The aerosol-generating article may comprise an air inlet at the upstream end of the aerosol-generating article, and the air inlet may be provided through the upstream element. The air entering through the air inlet may pass into the aerosol-generating element in order to generate the mainstream aerosol.

The upstream element may advantageously prevent direct physical contact with the upstream end of the aerosol-generating element. In particular, in embodiments where—as will be discussed in more detail below—the aerosol-generating element comprises a susceptor element embedded within an aerosol-generating substrate, the upstream element may prevent direct physical contact with the upstream end of the susceptor element. This helps to prevent the displacement or deformation of the susceptor element during handling or transport of the aerosol-generating article. This in turn helps to secure the form and position of the susceptor element. Furthermore, the presence of an upstream element may help prevent any loss of the aerosol-generating substrate, which may be advantageous, for example, if the aerosol-generating substrate contains a particulate material, such as a particulate plant material.

The upstream element may also provide an improved appearance to the upstream end of the aerosol-generating article. Furthermore, if desired, the upstream element may be used to provide information on the aerosol-generating article, such as information on brand, flavour, content, or details of the aerosol-generating device that the article is intended to be used with.

The segment of material of the upstream element may be in the form of a porous plug element. The porous plug element may have a porosity of at least about 50 percent in the longitudinal direction of the aerosol-generating article. More preferably, the porous plug element has a porosity of between about 50 percent and about 90 percent in the longitudinal direction. The porosity of the porous plug element in the longitudinal direction is defined by the ratio of the cross-sectional area of material forming the porous plug element and the internal cross-sectional area of the aerosol-generating article at the position of the porous plug element.

The porous plug element may be made of a porous material or may comprise a plurality of openings. This may, for example, be achieved through laser perforation. Preferably, the plurality of openings is distributed homogeneously over the cross-section of the porous plug element.

The porosity or permeability of the upstream element may advantageously be varied in order to provide a desirable overall resistance to draw of the aerosol-generating article.

In alternative embodiments, the upstream element may be formed from a material that is impermeable to air. In such embodiments, the aerosol-generating article may be configured such that air flows into the aerosol-generating element through suitable ventilation means provided in a wrapper.

The segment of material of the upstream element may comprise any material suitable for use in an aerosol-generating article. For example, the segment of material of the upstream element may comprise filter materials, ceramics, polymer materials, cellulose acetate, paper, cardboard, zeolite or aerosol-generating substrate. Preferably, the segment of material comprises a plug of cellulose acetate. In some embodiments, the segment of material of the upstream element is substantially made of paper.

Preferably, the upstream element has a diameter that is approximately equal to the diameter of the aerosol-generating article.

Preferably, the upstream element has an external diameter of at least about 5 millimetres. More preferably, the upstream element has an external diameter of at least about 6 millimetres. Even more preferably, the upstream element has an external diameter of at least about 7 millimetres.

The upstream element preferably has an external diameter of less than or equal to about 12 millimetres. More preferably, the upstream element has an external diameter of less than or equal to about 10 millimetres. Even more preferably, the upstream element has an external diameter of less than or equal to about 8 millimetres.

In some embodiments, the upstream element has an external diameter from about 5 millimetres to about 12 millimetres, preferably from about 5 millimetres to about 10 millimetres, more preferably from about 5 millimetres to about 8 millimetres. In other embodiments, the upstream element has an external diameter from about 6 millimetres to about 12 millimetres, preferably from about 6 millimetres to about 10 millimetres, more preferably from about 6 millimetres to about 8 millimetres. In further embodiments, the upstream element has an external diameter from about 7 millimetres to about 12 millimetres, preferably from about 7 millimetres to about 10 millimetres, more preferably from about 7 millimetres to about 8 millimetres.

The upstream element may have a length of at least about 1 millimetre. For example, the upstream element may have a length of at least about 2 millimetres, preferably at least about 4 millimetres, more preferably at least about 6 millimetres.

The upstream element may have a length of less than or equal to about 25 millimetres. For example, the upstream element may have a length of less than or equal to about 20 millimetres, preferably less than or equal to about 15 millimetres, more preferably less than or equal to about 12 millimetres, even more preferably less than or equal to about 10 millimetres. In particularly preferred embodiments, the upstream element has a length of less than or equal to about millimetres.

In some embodiments, the upstream element has a length of from about 1 millimetre to about 20 millimetres, preferably from about 1 millimetre to about 15 millimetres, more preferably from about 1 millimetre to about 12 millimetres, even more preferably from about 1 millimetre to about 10 millimetres, most preferably from about 1 millimetre to about 8 millimetres.

In other embodiments, the upstream element has a length of from about 2 millimetres to about 20 millimetres, preferably from about 2 millimetres to about 15 millimetres, more preferably from about 2 millimetres to about 12 millimetres, even more preferably from about 2 millimetres to about 10 millimetres, most preferably from about 2 millimetres to about 8 millimetres.

In further embodiments, the upstream element has a length of from about 4 millimetres to about 20 millimetres, preferably from about 4 millimetres to about 15 millimetres, more preferably from about 4 millimetres to about 12 millimetres, even more preferably from about 4 millimetres to about 10 millimetres, most preferably from about 4 millimetres to about 8 millimetres.

In yet other embodiments, the upstream element has a length of from about 6 millimetres to about 20 millimetres, preferably from about 6 millimetres to about 15 millimetres, more preferably from about 6 millimetres to about 12 millimetres, even more preferably from about 6 millimetres to about 10 millimetres, most preferably from about 6 millimetres to about 8 millimetres.

The length of the upstream element can advantageously be varied in order to adjust the overall length of the aerosol-generating article. For example, where it is desired to reduce the length of one of the other components of the aerosol-generating article, the length of the upstream element may be increased in order to maintain the same overall length of the article. Further, by adjusting the length of the upstream element, it may be possible to control by how much the aerosol-generating article projects out of the heating cavity of an aerosol-generating device when, during use, the aerosol-generating article is inserted into the heating cavity.

The segment of material of the upstream element preferably has a substantially homogeneous structure. For example, the segment of material of the upstream element may be substantially homogeneous in texture and appearance. The segment of material of the upstream element may, for example, have a continuous, regular surface over its entire cross section. The segment of material of the upstream element may, for example, have no recognisable symmetries.

The segment of material of the upstream element may be in the form of a tubular body. Thus, the segment of material of the upstream element may internally define a cavity extending from an upstream end of the tubular body to a downstream end of the tubular body. The tubular body may also comprise a folded end portion forming a first end wall at the upstream end of the tubular body. The first end wall may delimit an opening which permits airflow between the cavity and the exterior of the tubular body. Preferably, air may flow from the cavity through the opening and into the aerosol-generating element.

The tubular body may comprise a second end wall at the downstream end of the tubular body. This second end wall may be formed by folding an end portion of the tubular body at the downstream end of the tubular body. The second end wall may delimit an opening, which may also permit airflow between the cavity and the exterior of the tubular body. In the case of the second end wall, the opening may be configured to so that air may flow from the exterior of the aerosol-generating article through the opening and into the cavity. The opening may therefore provide a conduit through which air can be drawn into the aerosol-generating article and through the aerosol-generating substrate.

In certain embodiments, the segment of material comprises a convoluted sheet defining a plurality of longitudinally extending channels.

Inclusion of such a segment of material in the upstream element of an aerosol-generating article in accordance with the present invention may advantageously reduce or prevent aerosol-generating material being dislodged from the aerosol-generating element during storage, transportation and use of the aerosol-generating article while providing an acceptable RTD.

Inclusion of such a segment of material in the upstream element may advantageously reduce or prevent any aerosol-generating material dislodged from the aerosol-generating element from falling into a cavity of an aerosol-generating device during use of the aerosol-generating article. Inclusion of such a segment of material in the upstream element may advantageously restrict or prevent longitudinal movement of the aerosol-generating element during storage, transportation and use of the aerosol-generating article.

Preferably, the segment of material comprises a tubular portion defining an inner region of the upstream element, and the convoluted sheet is arranged within the tubular portion so that the plurality of longitudinally extending channels are defined in the inner region.

The convoluted sheet partitions the inner region of the upstream element into a plurality of longitudinally extending channels along which air may be drawn through the upstream element. The convoluted sheet may thereby reduce the cross-sectional area of empty space in the upstream element that aerosol-generating material in the aerosol-generating element may be dislodged into while providing an acceptable RTD. This may be particularly advantageous where the aerosol-generating substrate in the aerosol-generating element comprises a plurality of shreds, pellets, or granules of aerosol-generating material.

The convoluted sheet may have a basis weight of up to 200 grams per square metre. Preferably, the convoluted sheet has a basis weight of less than or equal to 150 grams per square metre. More preferably, the convoluted sheet has a basis weight of less than or equal to 100 grams per square metre.

Inclusion of a convoluted sheet having a basis weight of less than or equal to about 100 grams per square metre may enable the convoluted sheet to have a larger cross-sectional area while retaining an appropriate total weight of the upstream element. The convoluted sheet may thereby partition the inner region of the upstream element into a greater number of longitudinally extending channels, while retaining an appropriate total weight of the upstream element.

The convoluted sheet may advantageously act as a barrier to prevent or restrict longitudinal movement of the aerosol-generating substrate during storage, transportation and use of the aerosol-generating article.

Accordingly, the provision of an aerosol-generating article comprising an upstream element having the features describe above may improve the quality and consistency of aerosol delivered to a user compared to known heated tobacco products, and may allow optimal functioning of the aerosol-generating device of an aerosol-generating system in accordance with the second aspect of the invention.

The convoluted sheet comprises a plurality of turns. Preferably, the convoluted sheet comprises a plurality of non-concentric turns.

The convoluted sheet defines a plurality of longitudinally extending channels in the inner region of the upstream element. The convoluted sheet may have been one or more of crimped, folded, gathered, and pleated to define the plurality of longitudinally extending channels.

As used herein with reference to the invention, the term “crimped” denotes a convoluted sheet having a plurality of substantially parallel ridges or corrugations. Preferably, where the convoluted sheet has been crimped, the substantially parallel ridges or corrugations of the convoluted sheet extend in a longitudinal direction of the aerosol-generating article.

As used herein with reference to the invention, the term “gathered” denotes that a sheet is compressed or constricted substantially transversely relative to a longitudinal axis of the aerosol-generating article.

Preferably, the convoluted sheet has been crimped. This may advantageously reduce the variation in the cross-sectional area of the plurality of longitudinally extending channels defined by the convoluted sheet in the inner region of the upstream element.

Inclusion of a convoluted sheet that has been crimped in the upstream element may advantageously avoid or reduce the presence of longitudinally extending channels having a very large cross-sectional area in the inner region of the upstream element. The presence of longitudinally extending channels having a very large cross-sectional area in the inner region of the upstream element may adversely affect the ability of the upstream element to prevent or restrict upstream movement of aerosol-generating material from the aerosol-generating substrate.

Inclusion of a convoluted sheet that has been crimped in the upstream element may advantageously avoid or reduce the presence of longitudinally extending channels having a very small cross-sectional area in the inner region of the upstream element. The presence of longitudinally extending channels having a very small cross-sectional area in the inner region of the upstream element may increase the RTD of the upstream element beyond an acceptable or desired level.

Where the convoluted sheet has been crimped, adjacent ridges or corrugations of the convoluted sheet may be spaced apart from each other by less than or equal to about 1.2 millimetres, less than or equal to about 1 millimetre, or less than or equal to about 0.8 millimetres. For example, adjacent ridges or corrugations may be spaced apart from each other by less than or equal to about 0.5 millimetres. The spacing between adjacent ridges or corrugations may be selected based on a desired size of the plurality of longitudinally extending channels.

The convoluted sheet may have been crimped and then gathered. That is, the convoluted sheet may be a crimped and gathered sheet.

In general, the segment of material of the upstream element may have a weight of at least 10 milligrams, preferably at least 20 milligrams, more preferably at least 30 milligrams. The segment material of the upstream element may have a weight of less than or equal to 100 milligrams, preferably less than or equal to 75 milligrams, more preferably less than or equal to 50 milligrams. In some embodiments, the segment of material of the upstream element has a weight from 10 milligrams to 100 milligrams, preferably from 20 milligrams to 100 milligrams, more preferably from 30 milligrams to 100 milligrams. In other embodiments, the segment of material of the upstream element has a weight from 10 milligrams to 75 milligrams, preferably from 20 milligrams to 75 milligrams, more preferably from 30 milligrams to 75 milligrams. In further embodiments, the segment of material of the upstream element has a weight from 10 milligrams to 50 milligrams, preferably from 20 milligrams to 50 milligrams, more preferably from 30 milligrams to 50 milligrams. In some preferred embodiments, the segment of material of the upstream element may have a weight of about 40 milligrams.

The RTD of the segment of material of the upstream element may be at least about 1 millimetres H₂O, at least about 2 millimetres H₂O, or at least about 4 millimetres H₂O.

The RTD of the segment of material of the upstream element may be less than or equal to about 10 millimetres H₂O, less than or equal to about 8 millimetres H₂O, or less than or equal to about 6 millimetres H₂O.

The RTD of the segment of material of the upstream element may be between about 1 millimetres H₂O and about 10 millimetres H₂O, between about 1 millimetres H₂O and about 8 millimetres H₂O, or between about 1 millimetres H₂O and about 6 millimetres H₂O.

The RTD of the segment of material of the upstream element may be between about 2 millimetres H₂O and about 10 millimetres H₂O, between about 2 millimetres H₂O and about 8 millimetres H₂O, or between about 2 millimetres H₂O and about 8 millimetres H₂O.

The RTD of the segment of material of the upstream element may be between about 4 millimetres H₂O and about 10 millimetres H₂O, between about 4 millimetres H₂O and about 8 millimetres H₂O, or between about 4 millimetres H₂O and about 6 millimetres H₂O.

In some preferred embodiments, the RTD of the segment of material of the upstream element is about 5 millimetres H₂O or 5.5 millimetres H₂O.

In an aerosol-generating article in accordance with the present invention an upstream element as described above is provided upstream of an aerosol-generating element which, as mentioned previously, comprises a rod of aerosol-generating substrate circumscribed by a rod plug wrap. As used herein with reference to the invention, the term “rod” is used to denote a generally cylindrical element having a substantially circular, oval or elliptical cross-section.

The aerosol-generating element may have a length of at least about 8 millimetres, at least about 9 millimetres, or at least about 10 millimetres.

The aerosol-generating element may have a length of less than or equal to about 16 millimetres, less than or equal to about 15 millimetres, or less than or equal to about 14 millimetres.

The aerosol-generating element may have a length of between about 8 millimetres and about 16 millimetres, between about 8 millimetres and about 15 millimetres, or between about 8 millimetres and about 14 millimetres.

The aerosol-generating element may have a length of between about 9 millimetres and about 16 millimetres, between about 9 millimetres and about 15 millimetres, or between about 9 millimetres and about 14 millimetres.

The aerosol-generating element may have a length of between about 10 millimetres and about 16 millimetres, between about 10 millimetres and about 15 millimetres, or between about 10 millimetres and about 14 millimetres.

For example, the aerosol-generating element may have a length of about 12 millimetres. The ratio between the length of the aerosol-generating element to the total length of the aerosol-generating article may be at least about 0.10, at least about 0.15, or at least about 0.20.

The ratio between the length of the aerosol-generating element to the total length of the aerosol-generating article may be less than or equal to about 0.40, less than or equal to about 0.35, or less than or equal to about 0.3.

The ratio between the length of the aerosol-generating element to the total length of the aerosol-generating article may be between about 0.10 and about 0.40, between about 0.10 and about 0.35, or between about 0.10 and about 0.30.

The ratio between the length of the aerosol-generating element to the total length of the aerosol-generating article may be between about 0.15 and about 0.40, between about 0.15 and about 0.35, or between about 0.15 and about 0.30.

The ratio between the length of the aerosol-generating element to the total length of the aerosol-generating article may be between about 0.20 and about 0.40, between about 0.20 and about 0.35, or between about 0.20 and about 0.30.

Preferably, the aerosol-generating element has a substantially circular cross-section.

The aerosol-generating element may have an external diameter of at least about 5 millimetres, about 6 millimetres, or about 7 millimetres.

The aerosol-generating element may have an external diameter of less than or equal to 12 millimetres, less than or equal to about 10 millimetres, or less than or equal to about 8 millimetres.

The aerosol-generating element may have an external diameter of between about 5 millimetres and about 12 millimetres, between about 5 millimetres and about 10 millimetres, or between about 5 millimetres and about 8 millimetres.

The aerosol-generating element may have an external diameter of between about 6 millimetres and about 12 millimetres, between about 6 millimetres and about 10 millimetres, or between about 6 millimetres and about 8 millimetres.

The aerosol-generating element may have an external diameter of between about 7 millimetres and about 12 millimetres, between about 7 millimetres and about 10 millimetres, or between about 7 millimetres and about 8 millimetres.

For example, the aerosol-generating element may have an external diameter of about 7.1 millimetres.

The aerosol-generating substrate may have a density of at least about 150 milligrams per cubic centimetre, at least about 175 milligrams per cubic centimetre, at least about 200 milligrams per cubic centimetre, or at least about 250 milligrams per cubic centimetre.

The aerosol-generating substrate may have a density of less than or equal to about 500 milligrams per cubic centimetre, less than or equal to about 450 milligrams per cubic centimetre, less than or equal to about 400 milligrams per cubic centimetre, or less than or equal to about 350 milligrams per cubic centimetre.

The aerosol-generating substrate may have a density of between about 150 milligrams per cubic centimetre and about 500 milligrams per cubic centimetre, between about 150 milligrams per cubic centimetre and about 450 milligrams per cubic centimetre, between about 150 milligrams per cubic centimetre and about 400 milligrams per cubic centimetre, or between about 150 milligrams per cubic centimetre and about 350 milligrams per cubic centimetre.

The aerosol-generating substrate may have a density of between about 175 milligrams per cubic centimetre and about 500 milligrams per cubic centimetre, between about 175 milligrams per cubic centimetre and about 450 milligrams per cubic centimetre, between about 175 milligrams per cubic centimetre and about 400 milligrams per cubic centimetre, or between about 175 milligrams per cubic centimetre and about 350 milligrams per cubic centimetre.

The aerosol-generating substrate may have a density of between about 200 milligrams per cubic centimetre and about 500 milligrams per cubic centimetre, between about 200 milligrams per cubic centimetre and about 450 milligrams per cubic centimetre, between about 200 milligrams per cubic centimetre and about 400 milligrams per cubic centimetre, or between about 200 milligrams per cubic centimetre and about 350 milligrams per cubic centimetre.

The aerosol-generating substrate may have a density of between about 250 milligrams per cubic centimetre and about 500 milligrams per cubic centimetre, between about 250 milligrams per cubic centimetre and about 450 milligrams per cubic centimetre, between about 250 milligrams per cubic centimetre and about 400 milligrams per cubic centimetre, or between about 250 milligrams per cubic centimetre and about 350 milligrams per cubic centimetre.

For example, the aerosol-generating substrate may have a density of about 300 milligrams per cubic centimetre.

The RTD of the rod of aerosol-generating substrate may be at least about 4 millimetres H₂O, at least about 5 millimetres H₂O, or at least about 6 millimetres H₂O.

The RTD of the rod of aerosol-generating substrate may be less than or equal to about 10 millimetres H₂O, less than or equal to about 9 millimetres H₂O, or less than or equal to about 8 millimetres H₂O.

The RTD of the rod of aerosol-generating substrate may be between about 4 millimetres H₂O and about 10 millimetres H₂O, between about 4 millimetres H₂O and about 9 millimetres H₂O, or between about 4 millimetres H₂O and about 8 millimetres H₂O.

The RTD of the rod of aerosol-generating substrate may be between about 5 millimetres H₂O and about 10 millimetres H₂O, between about 5 millimetres H₂O and about 9 millimetres H₂O, or between about 5 millimetres H₂O and about 8 millimetres H₂O.

The RTD of the rod of aerosol-generating substrate may be between about 6 millimetres H₂O and about 10 millimetres H₂O, between about 6 millimetres H₂O and about 9 millimetres H₂O, or between about 6 millimetres H₂O and about 8 millimetres H₂O.

The aerosol-generating substrate may be a solid aerosol-generating substrate.

The aerosol-generating substrate preferably comprises an aerosol former.

The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Preferably, the aerosol former comprises one or more of glycerine and propylene glycol. The aerosol former may consist of glycerine or propylene glycol or of a combination of glycerine and propylene glycol.

The aerosol-generating substrate may comprise at least about 5 percent, at least about 10 percent, or at least about 12 percent by weight of aerosol former on a dry weight basis of the aerosol-generating substrate.

The aerosol-generating substrate may comprise less than or equal to about 30 percent, less than or equal to about 25 percent, or less than or equal to about 20 percent by weight of aerosol former on a dry weight basis of the aerosol-generating substrate.

The aerosol-generating substrate may comprise between about 5 percent and about 30 percent, between about 5 percent and about 25 percent, or between about 5 percent and about 20 percent by weight of aerosol former on a dry weight basis of the aerosol-generating substrate.

The aerosol-generating substrate may comprise between about 10 percent and about 30 percent, between about 10 percent and about 25 percent, or between about 10 percent and about 20 percent by weight of aerosol former on a dry weight basis of the aerosol-generating substrate.

The aerosol-generating substrate may comprise between about 12 percent and about 30 percent, between about 12 percent and about 25 percent, or between about 12 percent and about 20 percent by weight of aerosol former on a dry weight basis of the aerosol-generating substrate.

The aerosol-generating substrate may comprise a plurality of shreds of tobacco material. The aerosol-generating substrate may comprise a plurality of shreds of homogenised tobacco material.

As used herein with reference to the invention, the term “shred” denotes an element having a length substantially greater than a width and a thickness thereof.

As used herein with reference to the invention, the term “homogenised tobacco material” is used to describe material formed by agglomerating particulate tobacco material.

Shreds of homogenised tobacco material may be formed from a sheet of homogenised tobacco material, for example, by cutting or shredding. Shreds of homogenised tobacco material may be formed by other methods, for example, by extrusion.

The shreds of tobacco material may have a width of at least about 0.3 millimetres, at least about 0.5 millimetres, or at least about 0.6 millimetres.

The shreds of tobacco material may have a width of less than or equal to about 2 millimetres, less than or equal to about 1.2 millimetres, or less than about 0.9 millimetres.

The shreds of tobacco material may have a width of between about 0.3 millimetres and about 2 millimetres, between about 0.3 millimetres and about 1.2 millimetres, or between about 0.3 millimetres and about 0.9 millimetres.

The shreds of tobacco material may have a width of between about 0.5 millimetres and about 2 millimetres, between about 0.5 millimetres and about 1.2 millimetres, or between about 0.5 millimetres and about 0.9 millimetres.

The shreds of tobacco material may have a width of between about 0.6 millimetres and about 2 millimetres, between about 0.6 millimetres and about 1.2 millimetres, or between about 0.6 millimetres and about 0.9 millimetres.

The shreds of tobacco material may have a length of at least about 10 millimetres.

The shreds of tobacco material may have a length of less than or equal to about 40 millimetres.

The shreds of tobacco material may have a length of between about 10 millimetres and about 40 millimetres.

At least about 20 percent by weight of the plurality of shreds of tobacco material on a dry weight basis may extend along the entire length of the aerosol-generating substrate. At least about 20 percent by weight of the plurality of shreds of tobacco material on a dry weight basis may have a length substantially the same as the length of the aerosol-generating substrate.

Less than or equal to about 60 percent by weight of the plurality of shreds of tobacco material on a dry weight basis may extend along the entire length of the aerosol-generating substrate. Less than or equal to about 60 percent by weight of the plurality of shreds of tobacco material on a dry weight basis may have a length substantially the same as the length of the aerosol-generating substrate.

Between about 20 percent and 60 percent by weight of the plurality of shreds of tobacco material on a dry weight basis may extend along the entire length of the aerosol-generating substrate. Between about 20 percent and 60 percent by weight of the plurality of shreds of tobacco material on a dry weight basis may have a length substantially the same as the length of the aerosol-generating substrate.

The size of the aerosol-generating material of the aerosol-generating substrate, such as a plurality of shreds of tobacco material, may play a role in the distribution of heat inside the aerosol-generating substrate. Also, the size of the aerosol-generating material may play a role in the resistance to draw of the article. In addition, the size of the aerosol-generating material may affect the ability of the upstream element to prevent or restrict movement of the aerosol-generating material into the longitudinally extending channels of the upstream element. The size of the aerosol-generating material may also affect the ability of the upstream element to prevent or restrict upstream movement of the aerosol-generating material along the longitudinally extending channels and out of the upstream element.

The aerosol-generating substrate may comprise a plurality of pellets or granules of tobacco material. The aerosol-generating substrate may comprise a plurality of pellets or granules of homogenised tobacco material.

At least about 60 percent by weight of the plurality of pellets or granules may have a largest dimension greater than about 1 millimetre, at least about 70 percent by weight of the plurality of pellets or granules may have a largest dimension greater than about 1 millimetre, or at least about 80 percent by weight of the plurality of pellets or granules may have a largest dimension greater than about 1 millimetre.

Where the homogenised plant material is in the form of a plurality of pellets or granules, at least about 70 percent by weight of the plurality of pellets or granules may have a largest dimension greater than about 0.5 millimetres, at least about 80 percent by weight of the plurality of pellets or granules may have a largest dimension greater than about 0.5 millimetres, or at least about 90 percent by weight of the plurality of pellets or granules may have a largest dimension greater than about 0.5 millimetres.

For example, at least about 80 percent by weight of the plurality of pellets or granules may have a largest dimension greater than about 1 millimetre and at least about 90% by weight of the plurality of pellets or granules may have a largest dimension greater than about 0.5 millimetres.

The aerosol-generating substrate may comprise one or more sheets of tobacco material. The aerosol-generating substrate may comprise one or more sheets of homogenised tobacco material.

The one or sheets of tobacco material may each individually have a thickness of at least about 100 micrometres, at least about 150 micrometres, or at least about 300 micrometres.

As used herein with reference to the invention, individual thickness refers to the thickness of the individual sheet of tobacco material, whereas combined thickness refers to the total thickness of all sheets of tobacco material that make up the aerosol-generating substrate. For example, if the aerosol-generating substrate is formed from two individual sheets of tobacco material, then the combined thickness is the sum of the thickness of the two individual sheets of tobacco material or the measured thickness of the two sheets of tobacco material where the two sheets of tobacco material are stacked in the aerosol-generating substrate.

The one or more sheets of tobacco material may each individually have a thickness of less than or equal to about 600 micrometres, less than or equal to about 300 micrometres, or less than or equal to about 250 micrometres.

The one or more sheets of tobacco material may each individually have a thickness of between about 100 micrometres and about 600 micrometres, between about 100 micrometres and about 300 micrometres, or between about 100 micrometres and about 250 micrometres.

The one or more sheets of tobacco material may each individually have a thickness of between about 150 micrometres and about 600 micrometres, between about 150 micrometres and about 300 micrometres, or between about 150 micrometres and about 250 micrometres.

The one or more sheets of tobacco material may each individually have a thickness of between about 250 micrometres and about 600 micrometres, between about 250 micrometres and about 300 micrometres, or between about 250 micrometres and about 250 micrometres.

The one or more sheets of tobacco material may each individually have a length substantially the same as the length of the aerosol-generating substrate.

The one or more sheets of tobacco material may have been one or more of crimped, folded, gathered, and pleated.

Crimping, folding, gathering, or pleating of the one or more sheets of tobacco material may cause splitting of the one or more sheets of tobacco material to form shreds of tobacco material. For example, the one or more sheets of tobacco material may be crimped to such an extent that the integrity of the one or more sheets of tobacco material becomes disrupted at the plurality of parallel ridges or corrugations causing separation of the material, and results in the formation of shreds of tobacco material.

The aerosol-generating substrate may comprise a gel composition that includes nicotine, at least one gelling agent and an aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding. The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding. The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25° C., 50 percent by weight water/50 percent by weight glycerol mixture, in an amount of 0.3 percent by weight, increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight t.

The gel composition may further include an acid. The acid may comprise a carboxylic acid, such as levulinic acid or lactic acid.

The gel composition preferably comprises some water. The gel composition is more stable when the composition comprises some water. Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the aerosol-generating substrate comprises a porous medium loaded with the gel composition. The term “porous” is used herein to refer to a material that provides a plurality of pores or openings that allow the passage of air through the material.

The aerosol-generating substrate may comprise hydroxypropylmethyl cellulose and one or more cellulose based strengthening agents. An aerosol-forming substrate that includes a combination of hydroxypropylmethyl cellulose and a cellulose based strengthening agent may have a number of advantages. The inclusion of hydroxypropylmethyl cellulose in the aerosol-forming substrate may help in improving the manufacturing process of the aerosol-forming substrate. For example, hydroxypropylmethyl cellulose may reduce the overall viscosity of the slurry that is mixed when making the aerosol-forming substrate. A lower viscosity slurry may flow more easily compared to conventional slurries, and a lower viscosity slurry is easier to mix, transfer and handle during the manufacturing process. The inclusion of a cellulose based strengthening agent in the aerosol-forming substrate may increase the tensile strength of the aerosol-forming substrate. An aerosol-forming substrate with a higher tensile strength may be less likely to deteriorate or break, for example during transit or during the manufacturing process.

Additionally, it has been observed that using a cellulose based strengthening agent to increase the tensile strength of the aerosol-forming substrate may overcome a reduction in tensile strength which may be caused by the inclusion of hydroxypropylmethyl cellulose, whilst still providing the above mentioned processing advantages associated with hydroxypropylmethyl cellulose.

In preferred embodiments, the aerosol-generating substrate may comprise one or more aerosol formers, wherein the aerosol-forming substrate has an aerosol former content of greater than 30 percent by weight; hydroxypropylmethyl cellulose; and one or more cellulose based strengthening agents, wherein the one or more cellulose based strengthening agents comprises cellulose powder, and wherein the aerosol-forming substrate has a cellulose powder content of between about 0.5 percent by weight and about 50 percent by weight.

Including one or more aerosol formers in the aerosol-forming substrate improves the formation of aerosol. The one or more aerosol formers may comprise glycerine. The one or more aerosol formers may comprise propylene glycol. The one or more aerosol formers may include a combination of glycerine and propylene glycol.

Preferably, the hydroxypropylmethyl cellulose is low viscosity hydroxypropylmethyl cellulose. For example, the hydroxypropylmethyl cellulose may have a viscosity of 0.05 Pa/s. In some examples the hydroxypropylmethyl cellulose may have a viscosity of 0.015 Pa/s. In some examples the hydroxypropylmethyl cellulose may have a viscosity of between 0.015 Pa/s and 0.05 Pa/s. Advantageously, using low viscosity hydroxypropylmethyl cellulose may provide benefits during the manufacturing process. Use of low viscosity hydroxypropylmethyl cellulose may result in a low viscosity slurry being formed, which is easier to mix and transfer during manufacturing and processing.

The one or more cellulose based strengthening agents may comprise cellulose fibres. Advantageously, cellulose fibres may be a cellulose based strengthening agent that is particularly effective at increasing the tensile strength of an aerosol-forming substrate.

The aerosol-forming substrate comprising hydroxypropylmethyl cellulose and one or more cellulose based strengthening agents may further comprise nicotine. The nicotine may comprise one or more nicotine salts. The one or more nicotine salts may be selected from the list consisting of nicotine lactate, nicotine citrate, nicotine pyruvate, nicotine bitartrate, nicotine benzoate, nicotine pectate, nicotine alginate, and nicotine salicylate. The nicotine may comprise an extract of tobacco.

In certain embodiments, the aerosol-forming substrate comprising hydroxypropylmethyl cellulose and one or more cellulose based strengthening agents may further comprise one or more carboxylic acids. The one or more carboxylic acids comprise one or more of fumaric acid, lactic acid and levulinic acid.

In certain embodiments, the aerosol-forming substrate comprising hydroxypropylmethyl cellulose and one or more cellulose based strengthening agents may further comprise tobacco particles. For example, the aerosol-forming substrate may comprise 0.01 percent by weight of tobacco particles, preferably at least 1 percent by weight of tobacco particles, even more preferably at least 2 percent by weight of tobacco particles, particularly preferably at least 5 percent by weight of tobacco particles.

In certain embodiments, the aerosol-forming substrate comprising hydroxypropylmethyl cellulose and one or more cellulose based strengthening agents may further comprise carboxymethyl cellulose (CMC). For example, the aerosol-forming substrate may comprise 0.5 percent by weight of CMC, preferably at least 1 percent by weight of CMC, more preferably at least 2 percent by weight of CMC, even more preferably at least 4 percent by weight of CMC.

As mentioned above, the aerosol-generating element comprises a rod plug wrap circumscribing the rod of aerosol-generating substrate

The rod plug wrap may comprise paper wrapping material or a non-paper wrapping material. In preferred embodiments, the wrapping material of the rod plug wrap comprises paper. Suitable paper wrapping materials for use in embodiments of the invention are known in the art and include, but are not limited to: cigarette papers; and filter plug wraps. Suitable non-paper wrapping materials for use in embodiments of the invention are known in the art and include, but are not limited to sheets of homogenised tobacco materials and sheets of certain polymeric materials. In certain embodiments, the wrapping material of the rod plug wrap may be in the form of a laminate material comprising a plurality of layers. Preferably, the rod plug wrap is free of flame retardant compounds.

The aerosol-generating article may comprise a susceptor arranged within the aerosol-generating substrate. As used herein with reference to the present invention, the term “susceptor” refers to a material that can convert electromagnetic energy into heat. When located within a fluctuating electromagnetic field, eddy currents induced in the susceptor cause heating of the susceptor.

The susceptor is preferably arranged in thermal contact with the aerosol-generating substrate. Thus, when the susceptor heats up, the aerosol-generating substrate is heated by the susceptor to generate an aerosol. The susceptor may be arranged in direct physical contact with the aerosol-generating substrate.

The upstream element may advantageously prevent or restrict upstream movement of the susceptor during storage, transportation and use of the aerosol-generating article.

The susceptor may be an elongate susceptor.

As used herein with reference to the invention, the term “elongate” is used to describe a component of the aerosol-generating article having a length greater than the width and thickness thereof.

The elongate susceptor may be arranged substantially longitudinally within the aerosol-generating substrate. That is, the longitudinal axis of the elongate susceptor may be approximately parallel to the longitudinal axis of the aerosol-generating element. For example, the longitudinal axis of the elongate susceptor may be within plus or minus 10 degrees of parallel to the longitudinal axis of the aerosol-generating element. The elongate susceptor may be located in a radially central position within the rod of aerosol-generating substrate, and extend along the longitudinal axis of the aerosol-generating element.

The susceptor may extend from the downstream end of the aerosol-generating element towards the upstream end of the aerosol-generating element.

The susceptor may extend from the upstream end of the aerosol-generating element towards the downstream end of the aerosol-generating element.

The susceptor may extends from the upstream end of the aerosol-generating substrate to the downstream end of the aerosol-generating element. That is, the susceptor may extend along the entire length of the aerosol-generating element.

The length of the susceptor may be substantially the same as the length of the aerosol-generating element.

The susceptor may extend part way along the length of the aerosol-generating element.

The susceptor may be spaced apart from the downstream end of the aerosol-generating substrate.

The susceptor may be spaced apart from the upstream end of the aerosol-generating element.

The susceptor may be spaced apart from both a downstream end and an upstream end of the aerosol-generating element.

The length of the susceptor may be less than the length of the aerosol-generating element.

The susceptor may be entirely enclosed within the aerosol-generating substrate. That is, the aerosol-generating substrate may completely surround the susceptor.

The susceptor may be in the form of a pin, rod, strip or blade.

The susceptor may have a length of at least about 5 millimetres, at least about 6 millimetres, or at least about 8 millimetres.

The susceptor may have a length of less than or equal to about 15 millimetres, less than or equal to about 12 millimetres, or less than or equal to about 10 millimetres.

The susceptor may have a length of between about 5 millimetres and about 15 millimetres, between about 5 millimetres and about 12 millimetres, or between about 5 millimetres and about 10 millimetres.

The susceptor may have a length of between about 6 millimetres and about 15 millimetres, between about 6 millimetres and about 12 millimetres, or between about 6 millimetres and about 10 millimetres.

The susceptor may have a length of between about 8 millimetres and about 15 millimetres, between about 8 millimetres and about 12 millimetres, or between about 8 millimetres and about 10 millimetres.

The susceptor may have a width of at least about 1 millimetre.

The susceptor may have width of less than or equal to about 5 millimetres.

The susceptor may have a width of between about 1 millimetre and about 5 millimetres. The susceptor may have a thickness of at least about 0.01 millimetres, or at least about 0.5 millimetres.

The susceptor may have a thickness of less than or equal to about 2 millimetres, less than or equal to about 500 micrometres, or less than or equal to about 100 micrometres.

The susceptor may have a thickness of between about 10 micrometres and about 2 millimetres, between about 10 micrometres and about 500 micrometres, or between about 10 micrometres and about 100 micrometres.

The susceptor may have a thickness of between about 0.5 millimetres and about 2 millimetres.

The susceptor may have a substantially circular cross-section.

The susceptor may have a substantially constant cross-section along the length of the susceptor.

If the susceptor has the form of a strip or blade, the strip or blade may have a rectangular shape having a width of between about 2 millimetres to about 8 millimetres, or between about 3 millimetres to about 5 millimetres. By way of example, a susceptor in the form of a strip of blade may have a width of about 4 millimetres.

If the susceptor has the form of a strip or blade, the strip or blade may have a rectangular shape and a thickness of between about 0.03 millimetres to about 0.15 millimetres, or between about 0.05 millimetres to about 0.09 millimetres. By way of example, a susceptor in the form of a strip of blade may have a thickness of about 0.07 millimetres, or about 0.06 millimetres.

The susceptor may be formed from any material that can be inductively heated to a temperature sufficient to generate an aerosol from the aerosol-generating substrate. For example, the susceptor may comprise a metal or carbon.

The susceptor may comprise or consist of a ferromagnetic material, for example a ferromagnetic alloy, ferritic iron, or a ferromagnetic steel or stainless steel. A suitable susceptor may be, or comprise, aluminium. The susceptor may be formed from 400 series stainless steels, for example grade 410, or grade 420, or grade 430 stainless steel. Different materials will dissipate different amounts of energy when positioned within electromagnetic fields having similar values of frequency and field strength.

Thus, parameters of the susceptor such as material type, length, width, and thickness may all be altered to provide a desired power dissipation within a known electromagnetic field. The susceptor may be heated to a temperature in excess of 250 degrees Celsius.

Suitable susceptors may comprise a non-metallic core with a metal layer disposed on the non-metallic core, for example metallic tracks formed on a surface of a ceramic core. A susceptor may have a protective external layer, for example a protective ceramic layer or protective glass layer encapsulating the susceptor. The susceptor may comprise a protective coating formed by a glass, a ceramic, or an inert metal, formed over a core of susceptor material.

The susceptor may be a multi-material susceptor and may comprise a first susceptor material and a second susceptor material.

An aerosol-generating article in accordance with the present invention may additionally comprise a downstream section downstream of the aerosol-generating element. Where present, the downstream section is provided immediately downstream of the aerosol-generating element and extends from a downstream end of the aerosol-generating element to a downstream end of the aerosol-generating article.

The downstream section may comprise one or more component.

For example, the downstream section may comprise one or more of a support element, an aerosol-cooling element, a mouthpiece element.

At least one of the support element and the aerosol-cooling element may be in the form of a hollow tubular element. In some embodiments, both the support element and the aerosol-cooling element are in the form of hollow tubular elements, which may differ in length, internal diameter or both.

In an aerosol-generating article in accordance with the present invention, such a hollow tubular element provides an unrestricted flow channel. This means that the hollow tubular element provides a negligible level of RTD. As used herein with reference to the invention, the term “negligible level of RTD” is used to describe an RTD of less than 1 mm H₂O per 10 millimetres of length of the hollow tubular substrate element, less than 0.4 mm H₂O per 10 millimetres of length of the hollow tubular substrate element, or less than 0.1 mm H₂O per 10 millimetres of length of the hollow tubular substrate element. The flow channel should therefore be free from any components that would obstruct the flow of air in a longitudinal direction. Preferably, the flow channel is substantially empty.

The hollow tubular element may have a total length of at least about 6 millimetres, preferably at least about 8 millimetres, at least about 10 millimetres, at least about 12 millimetres, or at least about 15 millimetres.

The hollow tubular element may have a total length of less than or equal to about 30 millimetres, less than or equal to about 25 millimetres, or less than or equal to about 23 millimetres.

The hollow tubular element may have a total length of between about 10 millimetres and about 30 millimetres, between about 10 millimetres and about 25 millimetres, or between about 10 millimetres and about 23 millimetres.

The hollow tubular element may have a total length of between about 12 millimetres and about 30 millimetres, between about 12 millimetres and about 25 millimetres, or between about 12 millimetres and about 23 millimetres.

The hollow tubular element may have a total length of between about 12 millimetres and about 30 millimetres, between about 12 millimetres and about 25 millimetres, or between about 12 millimetres and about 23 millimetres.

The total length of the hollow tubular element may be selected based on a desired total length of the aerosol-generating article.

The hollow tubular element may be formed from any suitable material or combination of materials. For example, the hollow tubular element may be formed from one or more materials selected from the group consisting of: cellulose acetate; a paper based material such as paper or cardboard; and polymeric materials, such as low density polyethylene (LDPE). Other suitable materials include polyhydroxyalkanoate (PHA) fibres.

In some embodiments, a ventilation zone may be provided at a location downstream of the aerosol-generating element. A satisfactory cooling of the stream of aerosol generated upon heating the aerosol-generating substrate and drawn through the hollow tubular element may be achieved by providing a ventilation zone at a location along the hollow tubular element itself or at a location along an intermediate element provided between the hollow tubular element and the downstream end of the aerosol-generating article. Without wishing to be bound by theory, the temperature drop caused by the admission of cooler, external air into the aerosol-generating article downstream of the aerosol-generating element via the ventilation zone may have an advantageous effect on the nucleation and growth of aerosol particles.

The ventilation zone may comprise a plurality of perforations through a tubular wall of the hollow tubular element. The ventilation zone may comprise at least one circumferential row of perforations. The ventilation zone may comprise two circumferential rows of perforations. For example, the perforations may be formed online during manufacturing of the aerosol-generating article. Each circumferential row of perforations may comprise from 8 to 30 perforations.

As mentioned above, the downstream section of the aerosol-generating article may comprise a mouthpiece element located downstream of the aerosol-generating substrate and at the downstream end or mouth end or proximal end of the aerosol-generating article. The mouthpiece element may be a mouthpiece filter element. The mouthpiece element may comprise at least one filter segment. For example, the mouthpiece element may comprise one or more segments of a fibrous filtration material. Suitable fibrous filtration materials are known in the art. For example, the at least one mouthpiece filter segment may comprise a cellulose acetate filter segment formed of cellulose acetate tow.

The mouthpiece element may consist of a single filter segment. The mouthpiece element may include two or more filter segments axially aligned in an abutting end to end relationship with each other.

Parameters or characteristics described herein in relation to the mouthpiece element as a whole may equally be applied to a filter segment of the mouthpiece element.

The mouthpiece element may have a low particulate filtration efficiency.

The mouthpiece element may have an RTD of less than or equal to about 25 millimetres H₂O, less than or equal to about 20 millimetres H₂O, or less than or equal to about 15 millimetres H₂O.

The mouthpiece element may have an RTD of at least about 10 millimetres H₂O.

The mouthpiece element may have an RTD of between about 10 millimetres H₂O and to about 25 millimetres H₂O, between about 10 millimetres H₂O and to about 20 millimetres H₂O, or of between about 10 millimetres H₂O and to about 15 millimetres H₂O.

Preferably, the mouthpiece element has a substantially circular cross-section.

Preferably, the mouthpiece element has an external diameter that is substantially the same as the external diameter of the aerosol-generating article.

The mouthpiece element may have a length of at least about 3 millimetres, or at least about 5 millimetres.

The length of the mouthpiece element may be less than or equal to about 14 millimetres, preferably less than or equal to 12 millimetres, less than or equal to 10 millimetres or less than or equal to about 9 millimetres.

The length of the mouthpiece element may be between about 3 millimetres and about 11 millimetres, or between about 3 millimetres and about 9 millimetres.

The length of the mouthpiece element may be between about 5 millimetres and about 11 millimetres, or between about 5 millimetres and about 9 millimetres.

For example, the length of the mouthpiece element may be about 7 millimetres.

The length of the mouthpiece element may be selected based on a desired total length of the aerosol-generating article.

The mouthpiece element may be circumscribed by a plug wrap.

The mouthpiece element may be unventilated such that air does not enter the aerosol-generating article along the mouthpiece element.

The mouthpiece element may be connected to one or more adjacent components of the aerosol-generating article by means of a tipping wrapper.

The aerosol-generating article may define a mouth end cavity at the downstream end of the aerosol-generating article. For example, the mouthpiece element may itself be in the form of a hollow tubular element. As an alternative, the mouthpiece element may include a non-hollow segment immediately upstream of a hollow tubular segment provided at the downstream end of the mouthpiece element. As a further alternative, the mouth end cavity may be defined by an outer wrapper of the mouthpiece element extending beyond a downstream end of a segment of filtration material of the mouthpiece element.

The aerosol-generating article may have a total length of at least about 35 millimetres, at least about 38 millimetres, at least about 40 millimetres, or at least about 42 millimetres.

The aerosol-generating article may have a total length of less than or equal to about 100 millimetres, less than or equal to about 70 millimetres, less than or equal to about 60 millimetres, or less than or equal to 50 millimetres.

The aerosol-generating article may have a total length of between about 35 millimetres and about 100 millimetres, between about 35 millimetres and about 70 millimetres, between about 35 millimetres and about 60 millimetres, or between about 35 millimetres and about 50 millimetres.

The aerosol-generating article may have a total length of between about 38 millimetres and about 100 millimetres, between about 38 millimetres and about 70 millimetres, between about 38 millimetres and about 60 millimetres, or between about 38 millimetres and about 50 millimetres.

The aerosol-generating article may have a total length of between about 40 millimetres and about 100 millimetres, between about 40 millimetres and about 70 millimetres, between about 40 millimetres and about 60 millimetres, or between about 40 millimetres and about 50 millimetres.

The aerosol-generating article may have a total length of between about 42 millimetres and about 100 millimetres, between about 42 millimetres and about 70 millimetres, between about 42 millimetres and about 60 millimetres, or between about 42 millimetres and about 50 millimetres.

For example, the aerosol-generating article may have a total length of about 45 millimetres.

Preferably, the aerosol-generating article has a substantially circular cross-section.

The aerosol-generating article may have an external diameter of at least about 5 millimetres, at least about 6 millimetres, or at least about 7 millimetres.

The aerosol-generating article may have an external diameter of less than or equal to about 12 millimetres, less than or equal to about 10 millimetres, or less than or equal to about 8 millimetres.

The aerosol-generating article may have an external diameter of between about 5 millimetres and about 12 millimetres, between about 5 millimetres and about 10 millimetres, or between about 5 millimetres and about 8 millimetres.

The aerosol-generating article may have an external diameter of between about 6 millimetres and about 12 millimetres, between about 6 millimetres and about 10 millimetres, or between about 6 millimetres and about 8 millimetres.

The aerosol-generating article may have an external diameter of between about 7 millimetres and about 12 millimetres, between about 7 millimetres and about 10 millimetres, or between about 7 millimetres and about 8 millimetres.

For example, the aerosol-generating article may have an external diameter of about 7.1 millimetres.

According to a second aspect of the present invention, there is provided an aerosol-generating system comprising: an aerosol-generating article according to the first aspect of the invention; and an aerosol-generating device configured to heat the aerosol-generating substrate of the aerosol-generating article.

The aerosol-generating device comprises means for heating the aerosol-generating substrate to a temperature sufficient to generate an aerosol from the aerosol-generating substrate. Preferably, the aerosol-generating device comprises a housing defining a cavity configured to receive the aerosol-generating article, and means for heating the aerosol-generating substrate to a temperature sufficient to generate an aerosol from the aerosol-generating substrate when the aerosol-generating article is received within the cavity.

The aerosol-generating device may be a handheld aerosol-generating device.

The aerosol-generating device may be an electrically-operated aerosol-generating device.

The aerosol-generating device may comprise a power supply and control electronics.

The aerosol-generating device may comprise a battery and control electronics.

The aerosol-generating device may be configured to heat the aerosol-generating substrate internally. That is, the aerosol-generating device may be configured to supply heat to the aerosol-generating substrate from a location internal to the aerosol-generating article.

For example, in some embodiments the aerosol-generating device comprises a heater element configured to be inserted into the aerosol-generating element when the aerosol-generating article is received within the cavity of the aerosol-generating device.

In other embodiments, the aerosol-generating article comprises a susceptor element provided at a location within the aerosol-generating element, and the aerosol-generating device comprises an inductor coil positioned on or within the housing, a power supply of the aerosol-generating device being connected to the inductor coil and configured to provide a high frequency oscillating current to the inductor coil. This generates an alternating magnetic field that induces a voltage in the susceptor element. The induced voltage causes a current to flow in the susceptor element, and this current causes Joule heating of the susceptor element that, in turn, heats the aerosol-generating substrate. The aerosol-generating device may be capable of generating a fluctuating electromagnetic field having a magnetic field strength (H-field strength) of between 1 and 5 kilo amperes per metre (kA m), preferably between 2 and 3 kA/m, for example about 2.5 kA/m.

The aerosol-generating device may be configured to heat the aerosol-generating substrate externally. That is, the aerosol-generating device may be configured to supply heat to the aerosol-generating substrate from a location external to the aerosol-generating article. For example, in some embodiments the aerosol-generating device comprises a heater element located about a perimeter of the cavity and configured to heat the aerosol-generating substrate of the aerosol-generating article from an exterior of the aerosol-generating element of the aerosol-generating article.

The invention is defined in the claims. However, below there is provided a non-exhaustive list of non-limiting examples. Any one or more of the features of these examples may be combined with any one or more features of another example, embodiment, or aspect described herein.

### EXAMPLES

Example Ex1: An aerosol-generating article for generating an aerosol upon heating, the aerosol-generating article comprising: an aerosol-generating element comprising a rod of aerosol-generating substrate circumscribed by a rod plug wrap; an upstream element located upstream of the aerosol-generating element, wherein the upstream element comprises a segment of material circumscribed by a first wrapper; a second wrapper circumscribing both the upstream element and the aerosol-generating element. The first wrapper or the second wrapper or both comprise a flame retardant coating composition comprising one or more flame retardant compounds at a location along the segment of material of the upstream element.

Example Ex2: An aerosol-generating article according to example Ex1, wherein the first wrapper comprises a wrapping base material and the flame retardant composition is provided on a surface of the wrapping base material facing the segment of material of the upstream element, a surface of the wrapping base material facing away from the segment of material of the upstream element, or both.

Example Ex3: An aerosol-generating article according to example Ex1, wherein the first wrapper comprises a wrapping base material impregnated with the flame retardant composition.

Example Ex4: An aerosol-generating article according to example Ex1, wherein the second wrapper comprises a wrapping base material impregnated with the flame retardant composition.

Example Ex5: An aerosol-generating article according to example Ex1, wherein the first wrapper comprises a wrapping base material that includes the flame retardant composition.

Example Ex6: An aerosol-generating article according to example Ex1, wherein the second wrapper comprises a wrapping base material that includes the flame retardant composition.

Example Ex7: An aerosol-generating article according to any one of Examples Ex1 to Ex6, wherein the flame retardant composition comprises a polymer and a mixed salt based on at least one mono, di- and/or tri-carboxylic acid, at least one polyphosphoric, pyrophosphoric and/or phosphoric acid, and a hydroxide or a salt of an alkali or an alkaline earth metal, where the at least one mono, di- and/or tri-carboxylic acid and the hydroxide or salt form a carboxylate and the at least one polyphosphoric, pyrophosphoric and/or phosphoric acid and the hydroxide or salt form a phosphate.

Example Ex8: An aerosol-generating article according to Example Ex7, wherein the flame retardant composition comprises a carbonate of an alkali or an alkaline earth metal.

Example Ex9: An aerosol-generating article according to any one of Examples Ex1 to Ex6, wherein the flame retardant composition comprises cellulose modified with at least one C₁₀ or higher fatty acid, tall oil fatty acid (TOFA), phosphorylated linseed oil, phosphorylated downstream corn oil.

Example Ex10: An aerosol-generating article according to any one of the preceding Examples, wherein neither one of the first wrapper and the second wrapper comprises metal.

Example Ex11: An aerosol-generating article according to any one of the Examples Ex2 to Ex10, wherein the flame retardant composition is applied as a coating onto at least one side of a wrapping base material of the wrapper by an application process based on size pressing, spraying, printing or coating.

Example Ex12: An aerosol-generating article according to any one of the Examples Ex2 to Ex11, wherein the wrapping base material of first wrapper or the second wrapper or both is a paper material having a weight from 20 gsm to 110 gsm, preferably from 20 gms to 40 gsm. Example Ex13: An aerosol-generating article according to any one of the preceding Examples, wherein the segment of material comprises a plug of cellulose acetate.

Example Ex14: An aerosol-generating article according to any one of the preceding Examples, wherein the segment of material comprises a hollow tubular body.

Example Ex15: An aerosol-generating article according to any one of the preceding Examples, wherein the segment of material comprises a convoluted sheet defining a plurality of longitudinally extending channels.

Example Ex16: An aerosol-generating article according to Example Ex15, wherein the segment of material comprises a tubular portion defining an inner region of the upstream element, and the convoluted sheet is arranged within the tubular portion so that the plurality of longitudinally extending channels are defined in the inner region.

Example Ex17: An aerosol-generating article according to Example Ex15 or Ex16, wherein the convoluted sheet has a basis weight of less than or equal to about 100 grams per square metre.

Example Ex18: An aerosol-generating article according to any one of the preceding Examples, wherein the aerosol-generating substrate comprises at least 10 percent by weight of an aerosol former.

Example Ex19: An aerosol-generating article according to any one of Examples Ex1 to Ex18, wherein the aerosol-generating substrate comprises a plurality of shreds of tobacco material.

Example Ex20: An aerosol-generating article according to any one of Examples Ex1 to Ex18, wherein the aerosol-generating substrate comprises a plurality of pellets or granules of tobacco material.

Example Ex21: An aerosol-generating article according to any one of Examples Ex1 to Ex18, wherein the aerosol-generating substrate comprises one or more sheets of homogenised tobacco material.

Example Ex22: An aerosol-generating article according to any one of Examples Ex1 to Ex18, wherein the aerosol-generating substrate comprises a gel composition that includes nicotine, at least one gelling agent and an aerosol former.

Example Ex23: An aerosol-generating article according to any one of Examples Ex1 to Ex18, wherein the aerosol-generating substrate comprises hydroxypropylmethyl cellulose and one or more cellulose based strengthening agents.

Example Ex24: An aerosol-generating article according to any one of the preceding Examples, wherein the rod plug wrap is free of flame retardant compounds.

Example Ex25: An aerosol-generating article according to any one of Examples Ex2 to Ex24, wherein the wrapping base material of the first wrapper has a basis weight from 20 grams per square metre to 120 grams per square metre.

Example Ex26: An aerosol-generating article according to any one of Examples Ex2 to Ex24, wherein the wrapping base material of the first wrapper has a thickness from 20 micrometres to 110 micrometres.

Example Ex27: An aerosol-generating article according to any one of Examples Ex2 to Ex24, wherein the wrapping base material of the second wrapper has a basis weight from 20 grams per square metre to 60 grams per square metre.

Example Ex28: An aerosol-generating article according to any one of Examples Ex2 to Ex24, wherein the wrapping base material of the second wrapper has a thickness from 40 micrometres to 70 micrometres.

Example Ex29: An aerosol-generating article according to any one of the preceding Examples, wherein a ratio of total weight of flame retardant compound(s) to overall dry basis weight of the wrapper may be at least about 0.02.

Example Ex30: An aerosol-generating article according to any one of the preceding Examples, wherein a ratio of total weight of flame retardant compound(s) to overall dry basis weight of the wrapper is less than or equal to about 0.20.

Example Ex31: An aerosol-generating article according to any one of the preceding Examples, wherein the flame retardant composition is provided in a treated portion of the wrapper, the treated portion of the wrapper extending over at least 10 percent of an outer surface of the segment of material of the upstream element.

Example Ex31: An aerosol-generating article according to any one of the preceding Examples, wherein the flame retardant composition is provided in a treated portion of the wrapper, the treated portion of the wrapper extending over at least 40 percent of an outer surface of the segment of material of the upstream element.

Example Ex32: An aerosol-generating article according to any one of the preceding Examples, wherein the flame retardant composition is provided in a treated portion of the wrapper, the treated portion of the wrapper extending over at least 80 percent of an outer surface of the segment of material of the upstream element.

Example Ex34: An aerosol-generating article according to any one of the preceding Examples, wherein the flame retardant composition is provided in a treated portion of the wrapper, the treated portion of the wrapper extending over at least 90 percent of an outer surface of the segment of material of the upstream element.

Example Ex35: An aerosol-generating article according to any one of the preceding Examples, wherein the flame retardant composition is provided in a treated portion of the wrapper, the treated portion of the wrapper extending over at least 95 percent of an outer surface of the segment of material of the upstream element.

Example Ex36: An aerosol-generating article according to any one of the preceding Examples, wherein the flame retardant composition is provided in a treated portion of the wrapper, a length of the treated portion of the wrapper being at least 10 percent of a length of the segment of material of the upstream element.

Example Ex37: An aerosol-generating article according to any one of the preceding Examples, wherein the flame retardant composition is provided in a treated portion of the wrapper, a length of the treated portion of the wrapper being at least 40 percent of a length of the segment of material of the upstream element.

Example Ex38: An aerosol-generating article according to any one of the preceding Examples, wherein the flame retardant composition is provided in a treated portion of the wrapper, a length of the treated portion of the wrapper being at least 80 percent of a length of the segment of material of the upstream element.

Example Ex39: An aerosol-generating article according to any one of the preceding Examples, wherein the flame retardant composition is provided in a treated portion of the wrapper, a length of the treated portion of the wrapper being at least 90 percent of a length of the segment of material of the upstream element.

Example Ex40: An aerosol-generating article according to any one of the preceding Examples, wherein the flame retardant composition is provided in a treated portion of the wrapper, a length of the treated portion of the wrapper being at least 95 percent of a length of the segment of material of the upstream element.

Example Ex41: An aerosol-generating article according to any one of the preceding Examples, wherein the flame retardant composition is provided in a treated portion of the wrapper, at least about 10 grams of the flame retardant composition being provided in the treated portion per square metre of surface area of the treated portion.

Example Ex42: An aerosol-generating article according to any one of the preceding Examples, wherein the flame retardant composition is provided in a treated portion of the wrapper, less than or equal to 100 grams of the flame retardant composition being provided in the treated portion per square metre of surface area of the treated portion.

Example Ex43: An aerosol-generating article according to any one of the preceding Examples, wherein the flame retardant composition is provided in a treated portion of the wrapper, a content of the flame retardant compound or compounds in the treated portion being such that, when the aerosol-generating article is heated at 500 degrees Celsius using a resistively heated coil for at least 5 seconds the aerosol-generating article does not ignite.

Example Ex44: An aerosol-generating article according to any one of the preceding Examples, wherein the flame retardant composition is provided in a treated portion of the wrapper, a content of the flame retardant compound or compounds in the treated portion being such that, when the aerosol-generating article is heated at 500 degrees Celsius using a resistively heated coil for at least 30 seconds the aerosol-generating article does not ignite.

Example Ex45: An aerosol-generating article according to any one of the preceding Examples, wherein the upstream element has an external diameter of at least 5 millimetres.

Example Ex46: An aerosol-generating article according to any one of the preceding Examples, wherein the upstream element has an external diameter of less than or equal to 12 millimetres.

Example Ex47: An aerosol-generating article according to any one of the preceding Examples, wherein the upstream element has a length of at least 1 millimetre.

Example Ex48: An aerosol-generating article according to any one of the preceding Examples, wherein the upstream element has a length of less than or equal to 25 millimetres.

Example Ex49: An aerosol-generating article according to any one of the preceding Examples, wherein the upstream element has a weight of at least 10 milligrams.

Example Ex50: An aerosol-generating article according to any one of the preceding Examples, wherein the upstream element has a weight of less than or equal to 100 milligrams.

Example Ex51: An aerosol-generating article according to any one of the preceding Examples, wherein the segment of material of the upstream element has an RTD of at least 1 millimetres H₂O.

Example Ex52: An aerosol-generating article according to any one of the preceding Examples, wherein the segment of material of the upstream element has an RTD of less than or equal to 10 millimetres H₂O.

Example Ex53: An aerosol-generating system comprising an electrically operated aerosol-generating device and an aerosol-generating article according to any one of Examples Ex1 to Ex52, the aerosol-generating device comprising means for heating the aerosol-generating substrate to a temperature sufficient to generate an aerosol from the aerosol-generating substrate.

Examples will now be further described with reference to the drawings of the accompanying Figures in which:

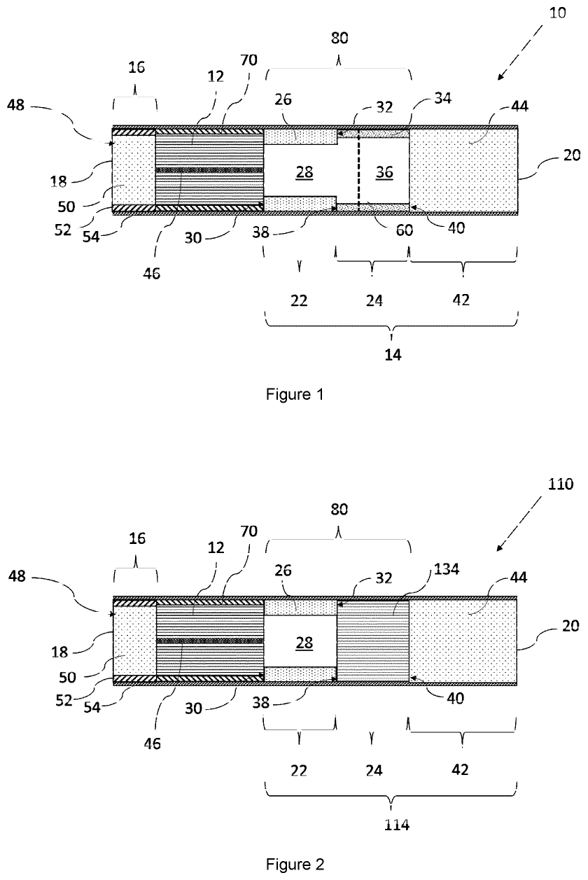

FIG. 1 shows a schematic side sectional view of an aerosol-generating article in accordance with an embodiment of the invention; and

FIG. 2 shows a schematic side sectional view of another aerosol-generating article in accordance with another embodiment of the invention.

The aerosol-generating article 10 shown in FIG. 1 comprises a rod 12 of aerosol-generating substrate 12 and a downstream section 14 at a location downstream of the rod 12 of aerosol-generating substrate. Further, the aerosol-generating article 10 comprises an upstream section 16 at a location upstream of the rod 12 of aerosol-generating substrate. Thus, the aerosol-generating article 10 extends from an upstream or distal end 18 to a downstream or mouth end 20.

The aerosol-generating article has an overall length of about 45 millimetres.

The downstream section 14 comprises a support element 22 located immediately downstream of the rod 12 of aerosol-generating substrate, the support element 22 being in longitudinal alignment with the rod 12. In the embodiment of FIG. 1, the upstream end of the support element 18 abuts the downstream end of the rod 12 of aerosol-generating substrate. In addition, the downstream section 14 comprises an aerosol-cooling element 24 located immediately downstream of the support element 22, the aerosol-cooling element 24 being in longitudinal alignment with the rod 12 and the support element 22. In the embodiment of FIG. 1, the upstream end of the aerosol-cooling element 24 abuts the downstream end of the support element 22. In the embodiment of FIG. 1, the support element 22 and the aerosol-cooling element 24 together define an intermediate hollow section 80 of the aerosol-generating article 10.

The support element 22 comprises a first hollow tubular segment 26. The first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment to a downstream end 32 of the first hollow tubular segment 20. The internal cavity 28 is substantially empty, and so substantially unrestricted airflow is enabled along the internal cavity 28.

The first hollow tubular segment 26 has a length of about 8 millimetres, an external diameter of about 7.25 millimetres, and an internal diameter of about 1.9 millimetres. Thus, a thickness of a peripheral wall of the first hollow tubular segment 26 is about 2.67 millimetres.

The aerosol-cooling element 24 comprises a second hollow tubular segment 34. The second hollow tubular segment 34 is provided in the form of a hollow cylindrical tube made of cellulose acetate. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36.

The second hollow tubular segment 34 has a length of about 8 millimetres, an external diameter of about 7.25 millimetres, and an internal diameter of about 3.25 millimetres. Thus, a thickness of a peripheral wall of the second hollow tubular segment 34 is about 2 millimetres. Thus, a ratio between the internal diameter of the first hollow tubular segment 26 and the internal diameter of the second hollow tubular segment 34 is about 0.75.

The aerosol-generating article 10 comprises a ventilation zone 60 provided at a location along the second hollow tubular segment 34. In more detail, the ventilation zone is provided at about 2 millimetres from the upstream end of the second hollow tubular segment 34. A ventilation level of the aerosol-generating article 10 is about 25 percent.

In the embodiment of FIG. 1, the downstream section 14 further comprises a mouthpiece element 42 at a location downstream of the intermediate hollow section 80. In more detail, the mouthpiece element 42 is positioned immediately downstream of the aerosol-cooling element 24. As shown in the drawing of FIG. 1, an upstream end of the mouthpiece element 42 abuts the downstream end 40 of the aerosol-cooling element 24.

The mouthpiece element 42 is provided in the form of a cylindrical plug 44 of low-density cellulose acetate. The mouthpiece element 42 has a length of about 12 millimetres and an external diameter of about 7.25 millimetres.

The rod 12 comprises an aerosol-generating substrate of one of the types described above.

The rod 12 of aerosol-generating substrate has an external diameter of about 7.25 millimetres and a length of about 12 millimetres.

The aerosol-generating article 10 further comprises an elongate susceptor 46 within the rod 12 of aerosol-generating substrate. In more detail, the susceptor 46 is arranged substantially longitudinally within the aerosol-generating substrate, such as to be approximately parallel to the longitudinal direction of the rod 12. As shown in the drawing of FIG. 1, the susceptor 46 is positioned in a radially central position within the rod and extends effectively along the longitudinal axis of the rod 12. In more detail, the susceptor 46 is in thermal contact with the aerosol-generating substrate. The susceptor 46 extends all the way from an upstream end to a downstream end of the rod 12. In effect, the susceptor 46 has substantially the same length as the rod 12 of aerosol-generating substrate.

In the embodiment of FIG. 1, the susceptor 46 is provided in the form of a strip and has a length of about 12 millimetres, a thickness of about 60 micrometres, and a width of about 4 millimetres.

The upstream section 16 comprises an upstream element 48 located immediately upstream of the rod 12 of aerosol-generating substrate, the upstream element 48 being in longitudinal alignment with the rod 12. In the embodiment of FIG. 1, the downstream end of the upstream element 48 abuts the upstream end of the rod 12 of aerosol-generating substrate. This advantageously prevents the susceptor 46 from being dislodged. Further, this ensures that the consumer cannot accidentally contact the heated susceptor 46 after use.

The upstream element 48 comprises a segment of material 50 in the form of a cylindrical plug of cellulose acetate and a first wrapper 52 circumscribing the segment of material 50. The segment of material 50 has a length of about 5 millimetres. The RTD of the segment of material 50 is about 30 millimetres H₂O.

The aerosol-generating article 10 further comprises a combining wrapper 54 which attaches the upstream element 48 to the remaining components of the aerosol-generating article.

In the embodiment of FIG. 1 a single combining wrapper 54 is depicted, which circumscribes and holds together the upstream element 48, the rod 12, and the downstream section 14 to form the aerosol-generating article.

However, it will be clear that alternative configurations are possible, wherein two or more combining wrappers are employed to assemble the different components of the aerosol-generating article. For example, a first combining wrapper could be used to attach the support element 22 to the aerosol-cooling element 24, and the resulting assembly could then be attached by means of a second combining wrapper to the upstream section 16 and the rod 12. The resulting combination of components could then be attached to the mouthpiece element 42 by means of a tipping wrapper.

The first wrapper 52 comprises a flame retardant composition at a location along the segment of material 50. In more detail, the first wrapper 52 is formed of a wrapping base material that has the flame retardant coating applied on a surface of the wrapping base material facing the segment of material 50.

In more detail, the flame retardant coating is provided at least in a treated portion of the first wrapper extending 52 between the proximal end and the distal end of the segment of material 50. The treated portion comprises about 15 grams of flame retardant compounds per square metre of surface area of the treated portion. Thus, the treated portion of the wrapper 52 has an overall basis weight greater than the basis weight of the wrapping base material. In the embodiment of FIG. 1, the treated portion has a length substantially matching the length of the segment of material 50, and extends substantially over the whole outer surface area of the segment of material 50.

As shown in the drawing of FIG. 1, the aerosol-generating article 10 further comprises a wrapper 70 circumscribing the rod 12 of aerosol-generating substrate. The wrapper 70 is separate and distinct from the first wrapper 52 circumscribing the segment of material 50. Neither one of the first wrapper 52 and the wrapper 70 comprises a metallic foil. The combining wrapper 54 described above circumscribes both the first wrapper 52 circumscribing the segment of material 50 and the wrapper 70 circumscribing the rod 12 of aerosol-generating substrate.

The aerosol-generating article 110 shown in FIG. 2 has a number of features in common with the aerosol-generating article 10 of FIG. 1, and will be described below insofar as it differs from the aerosol-generating article 10.

As shown in FIG. 2, the aerosol-generating article 110 comprises a rod 12 of aerosol-generating substrate 12 and a modified downstream section 114 at a location downstream of the rod 12 of aerosol-generating substrate.

Like the downstream section 14 of the aerosol-generating article 10 of FIG. 1, the modified downstream section 114 of the aerosol-generating article 110 of FIG. 2 comprises a support element 22 located immediately downstream of the rod 12 of aerosol-generating substrate, the support element 22 being in longitudinal alignment with the rod 12, wherein the upstream end of the support element 22 abuts the downstream end of the rod 12 of aerosol-generating substrate.

Further, the modified downstream section 114 comprises an aerosol-cooling element 134 located immediately downstream of the support element 22, the aerosol-cooling element 134 being in longitudinal alignment with the rod 12 and the support element 22. In more detail, the upstream end of the aerosol-cooling element 134 abuts the downstream end of the support element 22.

In contrast to the downstream section 14 of the aerosol-generating article 10, the aerosol-cooling element 134 of the modified downstream section 114 comprises a plurality of longitudinally extending channels which offer a low or substantially null resistance to the passage of air through the rod. In more detail, the aerosol-cooling element 134 is formed from a preferably non-porous sheet material selected from the group comprising a metallic foil, a polymeric sheet, and a substantially non-porous paper or cardboard. In particular, in the embodiment illustrated in FIG. 2, the aerosol-cooling element 134 is provided in the form of a crimped and gathered sheet of polylactic acid (PLA). The aerosol-cooling element 134 has a length of about 8 millimetres, and an external diameter of about 7.25 millimetres.

Similar to the embodiment of FIG. 1, the aerosol-generating article 110 of FIG. 2 comprises an upstream section 16 including an upstream element 48 located immediately upstream of the rod 12 of aerosol-generating substrate, the upstream element 48 being in longitudinal alignment with the rod 12. The upstream element 48 comprises a segment of material 50 in the form of a cylindrical plug of cellulose acetate and a first wrapper 52 circumscribing the segment of material 50. The segment of material 50 has a length of about 5 millimetres. The RTD of the segment of material 50 is about 30 millimetres H₂O.

The aerosol-generating article 10 further comprises a combining wrapper 54 which attaches the upstream element 48 to the remaining components of the aerosol-generating article. In the embodiment of FIG. 1 a single combining wrapper 54 is depicted, which circumscribes and holds together the upstream element 48, the rod 12, and the downstream section 14 to form the aerosol-generating article.

The first wrapper 52 comprises a flame retardant composition at a location along the segment of material 50. In more detail, the first wrapper 52 is formed of a wrapping base material that has the flame retardant coating applied on a surface of the wrapping base material facing away from the segment of material 50.

In more detail, the flame retardant coating is provided at least in a treated portion of the first wrapper extending 52 between the proximal end and the distal end of the segment of material 50. The treated portion comprises about 15 grams of flame retardant compounds per square metre of surface area of the treated portion. Thus, the treated portion of the wrapper 52 has an overall basis weight greater than the basis weight of the wrapping base material. In the embodiment of FIG. 2, the treated portion has a length substantially matching the length of the segment of material 50, and extends substantially over the whole outer surface area of the segment of material 50.

Additionally, in the embodiment of FIG. 2 the combining wrapper 54, which circumscribes the upstream element 48 and attaches the upstream element 48 to the remainder the aerosol-generating article also comprises a flame retardant at a location along the segment of material 50 of the upstream element 48. In more detail, the combining wrapper 54 is formed of a wrapping base material that has the flame retardant coating applied on a surface of the wrapping base material facing away from the segment of material 50.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article, comprising:
an aerosol-generating element comprising a rod of aerosol-generating substrate circumscribed by a rod plug wrap;
an upstream element located upstream of the aerosol-generating element, wherein the upstream element comprises a segment of material circumscribed by a first wrapper, and wherein the segment of material comprises a convoluted sheet defining a plurality of longitudinally extending channels; and
a second wrapper circumscribing both the upstream element and the aerosol-generating element,
wherein the first wrapper or the second wrapper or both the first wrapper and the second wrapper comprise a flame retardant composition comprising one or more flame retardant compounds at a location along the segment of material of the upstream element.

17. The aerosol-generating article according to claim 16, wherein the first wrapper comprises a wrapping base material and the flame retardant composition is provided on a surface of the wrapping base material facing the segment of material of the upstream element, a surface of the wrapping base material facing away from the segment of material of the upstream element, or both.

18. The aerosol-generating article according to claim 16, wherein the second wrapper comprises a wrapping base material and the flame retardant composition is provided on a surface of the wrapping base material facing the segment of material of the upstream element, a surface of the wrapping base material facing away from the segment of material of the upstream element, or both.

19. The aerosol-generating article according to claim 16,
wherein the flame retardant composition comprises a polymer and a mixed salt based on at least one mono, di-, and/or tri-carboxylic acid, at least one polyphosphoric, pyrophosphoric, and/or phosphoric acid, and a hydroxide or a salt of an alkali or an alkaline earth metal, and
wherein the at least one mono, di-, and/or tri-carboxylic acid and the hydroxide or salt form a carboxylate and the at least one polyphosphoric, pyrophosphoric, and/or phosphoric acid and the hydroxide or salt form a phosphate.

20. The aerosol-generating article according to claim 16, wherein the flame retardant composition comprises cellulose modified with at least one C₁₀ or higher fatty acid, tall oil fatty acid (TOFA), phosphorylated linseed oil, phosphorylated downstream corn oil.

21. The aerosol-generating article according to claim 17, wherein the flame retardant composition is applied as a coating onto at least one side of a wrapping base material of the wrapper by an application process based on size pressing, spraying, printing, or coating.

22. The aerosol-generating article according to claim 16, wherein the segment of material further comprises a plug of cellulose acetate.

23. The aerosol-generating article according to claim 16, wherein the segment of material further comprises a hollow tubular body.

24. The aerosol-generating article according to claim 16, wherein the aerosol-generating substrate comprises at least 10 percent by weight of an aerosol former.

25. The aerosol-generating article according to claim 16, wherein the aerosol-generating substrate comprises a plurality of shreds of tobacco material.

26. The aerosol-generating article according to claim 16, wherein the aerosol-generating substrate comprises one or more sheets of homogenised tobacco material.

27. The aerosol-generating article according to claim 16, wherein the aerosol-generating substrate comprises a gel composition that includes nicotine, at least one gelling agent, and an aerosol former.

28. The aerosol-generating article according to claim 16, wherein the aerosol-generating substrate comprises hydroxypropylmethyl cellulose and one or more cellulose based strengthening agents.

29. An aerosol-generating system comprising an electrically operated aerosol-generating device and the aerosol-generating article according to claim 16, the aerosol-generating device comprising means for heating the aerosol-generating substrate to a temperature sufficient to generate an aerosol from the aerosol-generating substrate.
